(19) United States
(12) Patent Application Publication
(10) Pub. No.: US 2024/0106605 A1
(43) Pub. Date: Mar. 28, 2024

(54) CONFIGURATION OF SOUNDING REFERENCE SIGNALS BASED ON USER EQUIPMENT REPORTING

(71) Applicant: QUALCOMM Incorporated, San Diego, CA (US)

(72) Inventors: Kexin Xiao, Shanghai (CN); Muhammad Sayed Khairy Abdelghaffar, San Jose, CA (US); Ahmed Elshafie, San Diego, CA (US); Yu Zhang, San Diego, CA (US)

(21) Appl. No.: 18/547,528

(22) PCT Filed: Apr. 2, 2021
(86) PCT No.: PCT/CN2021/085219

§ 371 Date: Aug. 23, 2023

(51) Int. Cl. H04L 5/00

(52) U.S. Cl. CPC H04L 5/0051; H04L 5/0021

(57) ABSTRACT

In an aspect of the disclosure, a method, a computer-readable medium, and an apparatus are provided. The apparatus may be a UE configured to receive configuration information indicating at least one cover code from a base station. The apparatus may be further configured to transmit at least one SRS to which the at least one cover code is applied in an SRS resource of an SRS resource set that is based on the configuration information. Another apparatus of the disclosure may be a base station configured to transmit configuration information indicating at least one cover code to a UE. The other apparatus may be further configured to receive at least lone SRS to which the at least one cover code is applied in an SRS resource of an SRS resource set that is based on the configuration information.

### BACKGROUND

### Technical Field

The present disclosure generally relates to communication systems, and more particularly, to configuration of sounding reference signal (SRS) transmission by a base station using information reported by a user equipment (UE).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In various wireless and radio access networks, channel sounding is an approach to calculating or estimating a wireless communications environment. For example, channel sounding may be useful in addressing the multipath effect. Illustratively, some example radio access technologies (RATs), such as a 5G New Radio (NR) access network, a base station may estimate at least one channel on which transmissions are received from a user equipment (UE) (e.g., an uplink channel) using at least one sounding reference signal (SRS). Potentially, SRS can be used for uplink frequency selective scheduling and/or uplink timing estimation in some wireless access networks.

Accordingly, the UE transmits at least one SRS to the base station. In so doing, the UE may sound all antenna ports of an SRS resource in each symbol of the SRS resource. In some aspects, the UE may aperiodically transmit SRSs to the base station, with such aperiodic SRS transmission being triggered by the base station, for example, via downlink or uplink downlink control information (DCI) (e.g., SRS request field).

Thus, SRS transmission is important to the connectivity of UE in access networks. However, the sounding of antenna ports of an SRS resource in symbols inherently consumes some amount of resources. As the number of UEs continues to rapidly grow, with such growth expected to continue, the conservation of finite resources is of increasing significance.

To that point, increasing and varied UE deployments are outpacing a proportional number of the base station deployments, which often leads to decreased coverage and signal quality for UEs finding themselves relatively closer to cell edges than to the base stations providing those cells. Such UEs having limited or reduced coverage relatively to other UEs closer to base stations may use increased transmission powers that may further increase inter-cell interference. As SRS transmission cannot be dispensed with and should scale to meet evolving use cases, a need exists for approaches to increasing the number of SRS transmissions that can be contemporaneously performed.

In an aspect of the disclosure, a method, a computer-readable medium, and an apparatus are provided. The apparatus may be a UE or component thereof configured to receive configuration information indicating at least one cover code from a base station. The apparatus may be further configured to transmit at least one SRS to which the at least one cover code is applied in an SRS resource of an SRS resource set that is based on the configuration information.

In another aspect of the disclosure, a method, a computer-readable medium, and an apparatus are provided. The apparatus may be a base station or component thereof configured to transmit configuration information indicating at least one cover code to a UE. The apparatus may be further configured to receive at least one SRS to which the at least one cover code is applied in an SRS resource of an SRS resource set that is based on the configuration information.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink channels within a subframe, in accordance with various aspects of the present disclosure.

FIG. 3 is a diagram illustrating an example of a base station and user equipment (UE) in an access network.

FIG. 4 is a diagram illustrating example configurations of sounding reference signal (SRS) resources for SRS transmission.

FIG. 5 is a call flow diagram illustrating example operations and communications flow for an SRS transmission that is configured using UE-reported information.

FIG. 6 is a diagram illustrating an example cover code that may be applied for SRS transmission.

FIG. 7 is a diagram illustrating an example of a time-domain cover code applied for transmission of pilot signals.

FIG. 8 is a diagram illustrating an example of delay spread for signals on transmission combs with cyclic shifting applied.

FIG. 9 is a diagram illustrating an example of code size configuration for TD-OCC used with SRS.

FIG. 10 is a diagram illustrating an example of a cover code for an SRS resource in the time domain.

FIG. 11 is a diagram illustrating an example of a cover code for an SRS resource in the frequency domain.

FIG. 12 is a diagram illustrating an example of cover codes for an SRS resource in the time and frequency domains.

FIG. 13 is a diagram illustrating another example of cover codes for an SRS resource in the time and frequency domains.

FIG. 14 is a diagram illustrating an example discrete Fourier transform (DFT) code that may be applied in the time and frequency domains with an SRS resource.

FIG. 15 is a diagram illustrating example DFT sequences in the time and frequency domains for SRS resources.

FIG. 16 is a flowchart of an example method of wireless communication by a UE.

FIG. 17 is a flowchart of an example method of wireless communication by a base station.

FIG. 18 is a flowchart of another example method of wireless communication by a UE.

FIG. 19 is a flowchart of another example method of wireless communication by a base station.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, computer-executable code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or computer-executable code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer-executable code in the form of instructions or data structures that can be accessed by a computer.

In various wireless and radio access networks, channel sounding is an approach to calculating or estimating a wireless communications environment. For example, channel sounding may be useful in addressing the multipath effect. Illustratively, some example radio access technologies (RATs), such as a 5G New Radio (NR) access network, a base station may estimate at least one channel on which transmissions are received from a user equipment (UE) (e.g., an uplink channel) using at least one sounding reference signal (SRS). Potentially, SRS can be used for uplink frequency selective scheduling and/or uplink timing estimation in some wireless access networks.

Accordingly, the UE transmits at least one SRS to the base station. In so doing, the UE may sound all antenna ports of an SRS resource in each symbol of the SRS resource. In some aspects, the UE may aperiodically transmit SRSs to the base station, with such aperiodic SRS transmission being triggered by the base station, for example, via downlink or uplink downlink control information (DCI) (e.g., SRS request field).

Thus, SRS transmission is important to the connectivity of UE in access networks. However, the sounding of antenna ports of an SRS resource in symbols inherently consumes some amount of resources. As the number of UEs continues to rapidly grow, with such growth expected to continue, the conservation of finite resources is of increasing significance. As SRS transmission cannot be dispensed with, a need exists for approaches to increasing the number of SRS transmissions that can be contemporaneously performed.

Moreover, the areas in which UEs are now implemented is so diverse that many procedures and practices that have been universally applied across all (or a majority of) UEs may be inefficient or otherwise disadvantageous to many UE implementations and/or deployments. In particular, with the growth of the Internet of Things (IoT), UEs are frequently deployed at stationary positions, such as with a sensor/actuators (S/As), or in other deployments that traditionally may not have been described as suitable for UEs, such as in automobiles and unmanned aerial vehicles (UAVs).

Consequently, some procedures and configurations may be more suitable for some UEs than others. Such differences may be particularly manifest in the various communications that are affected by UE mobility, as signals communicated with UEs that are highly mobile may be affected differently from those communicated with UEs that are stationary or have low mobility. Additionally, the wireless communications environments relevant to highly mobile UEs may change relatively frequently, whereas those relevant to lower mobility UEs may be reasonably stable (e.g., some S/As may be stationary in locations with little activity influencing over-the-air signaling).

Due to such differences across various UEs and the applicable environments, certain configurations for SRS transmission may be more suitable for highly mobile UEs than UEs having lower mobility, and vice versa. Therefore, a further need exists for approaches to configuring SRS resources in ways that are suitable for different UE characteristics and wireless communications environments.

The present disclosure describes various techniques and solutions that address the foregoing needs in the context of sounding procedures. In some example aspects described herein, one or more cover codes may be applied across SRS resources to sound antenna ports of a UE. For example, the one or more cover codes may be applied in the time domain, the frequency domain, or both the time and frequency domain. Potentially, at least one of the cover codes described by the present disclosure may increase the capacity for SRS transmission while maintaining the diversity gain as symbol repetitions.

Further, UE mobility may affect channel sounding by UEs to such a degree that commonly configuring high-mobility UEs and low-mobility UEs may be unsuitable for some access networks. Therefore, the present disclosure describes various techniques and solutions to adapting the configurations of sounding procedures for varying UE mobility. While base stations may configure SRS resources for UEs, the base stations may be unable to accurately assess some factors that may be considered in configuring SRS resources. For example, the Doppler effect and delay spread may affect communications in the time domain with highly mobile UEs to an appreciable degree, whereas Doppler effect and delay spread may be less significant, or even negligible, in communications in the time domain with lower mobility UEs. However, the limited transmission powers of UEs may render uplink signals inaccurate (or at least lacking precision) for tracking UEs, e.g., in the context of Doppler effect measurements and/or delay spread measurements. Rather, UEs may be better positioned to assess these measurements, due in part to the higher transmit powers of base stations.

In view of the foregoing, the present disclosure further describes various techniques and solutions for configuring SRS resources by a base station according to UE-reported information, such as Doppler effect and delay spread. The present disclosure describes such SRS resource configuration in some example contexts, including the application of cover codes. For example, the present disclosure provides for configuring cover codes for SRS resources in a manner that accounts for variations in Doppler effect, delay spread, or other characteristics affected by UE mobility. The concepts and aspects described in the present disclosure may improve channel sounding procedures in some access networks. Additional or alternative concepts and aspects, as well as the various benefits thereof, will be apparent to those of ordinary skill in the art in the description, figures, and claims of the present disclosure.

Although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies. For example, some concepts and aspects described herein may be applied with Wi-Fi or other network technologies, including wide area networks or personal area networks.

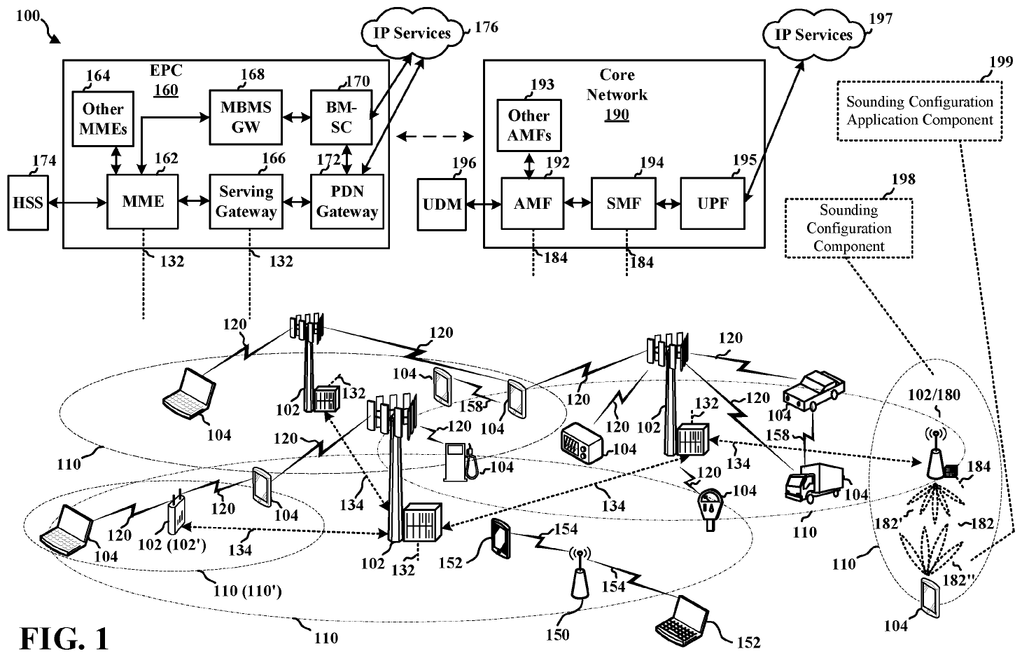

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR, which may be collectively referred to as Next Generation radio access network (RAN) (NG-RAN), may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, Multimedia Broadcast Multicast Service (MBMS), subscriber and equipment trace, RAN information management (RIM), paging, positioning, and delivery of warning messages.

In some aspects, the base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless. At least some of the base stations 102 may be configured for integrated access and backhaul (IAB). Accordingly, such base stations may wirelessly communicate with other such base stations. For example, at least some of the base stations 102 configured for IAB may have a split architecture that includes at least one of a central unit (CU), a distributed unit (DU), a radio unit (RU), a remote radio head (RRH), and/or a remote unit, some or all of which may be collocated or distributed and/or may communicate with one another. In some configurations of such a split architecture, the CU may implement some or all functionality of a radio resource control (RRC) layer, whereas the DU may implement some or all of the functionality of a radio link control (RLC) layer.

Illustratively, some of the base stations 102 configured for IAB may communicate through a respective CU with a DU of an IAB donor node or other parent IAB node (e.g., a base station), further, may communicate through a respective DU with child IAB nodes (e.g., other base stations) and/or one or more of the UEs 104. One or more of the base stations 102 configured for IAB may be an IAB donor connected through a CU with at least one of the EPC 160 and/or the core network 190. In so doing, the base station(s) 102 operating as an IAB donor(s) may provide a link to the one of the EPC 160 and/or the core network 190 for other IAB nodes, which may be directly or indirectly (e.g., separated from an IAB donor by more than one hop) and/or one or more of the UEs 104, both of which may have communicate with a DU(s) of the IAB donor(s). In some additional aspects, one or more of the base stations 102 may be configured with connectivity in an open RAN (ORAN) and/or a virtualized RAN (VRAN), which may be enabled through at least one respective CU, DU, RU, RRH, and/or remote unit.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to downlink and uplink (e.g., more or fewer carriers may be allocated for downlink than for uplink). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the downlink/uplink WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (or “mmWave” or simply “mmW”) band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1 (e.g., up to 7.125 GHz), or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a Packet Switch (PS) Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a PS Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, an example base station 102/180 and an example UE 104 may be configured to perform a channel sounding procedure in which the base station 102/180 configures SRS resources for the UE 104 and the UE 104 transmits SRSs on the SRS resources based on the configuration by the base station 102/180. Some or all of the various concepts and aspects described herein with respect to a base station may be implemented by a Sounding Configuration Component 198. Some or all of the various concepts and aspects described herein with respect to a UE may be implemented by a Sounding Configuration Application Component 199.

In some aspects of the UE 104, the Sounding Configuration Application Component 199 may be configured report, to the base station 102/180, information indicating a set of channel properties of a wireless channel on which communication with the base station 102/180 is configured. Each of the set of channel properties may be based on the UE 104 receiving a set of pilot signals from the base station 102/180. The set of channel properties may indicate at least one Doppler shift, at least one Doppler spread, and/or at least one delay spread corresponding to at least one antenna port, which may be a logical port defined as the channel on which a symbol on the antenna port is conveyed that can be inferred from the channel on which another symbol on the same antenna port is conveyed. Further, the Sounding Configuration Application Component 199 may be configured to transmit at least one SRS of an SRS resource set to the base station 102/180 according to a configuration, received from the base station 102/180, that is based on the information indicating the set of channel properties.

In some aspects of the base station 102/180, the Sounding Configuration Component 198 may be configured to receive information indicating a set of channel properties of a wireless channel on which communication with the UE 104 is configured. Each of the set of channel properties may be based on a set of pilot signals transmitted by the base station 102/180 and received by the UE 104 on the wireless channel. The Sounding Configuration Component 198 may be further configured to receive at least one SRS of an SRS resource set from the UE 104 according to a configuration that is based on the information indicating the set of channel properties.

In some other aspects of the UE 104, the Sounding Configuration Application Component 199 may be configured to receive configuration information indicating at least one cover code from a base station 102/180. The Sounding Configuration Application Component 199 may be further configured to transmit at least one SRS to which the at least one cover code is applied in an SRS resource set that is based on the configuration information.

In some other aspects of the base station 102/180, the Sounding Configuration Component 198 may be configured to transmit configuration information indicating at least one cover code to the UE 104. The Sounding Configuration Component 198 may be further configured to receive at least one SRS to which the at least one cover code is applied in an SRS resource set that is based on the configuration information.

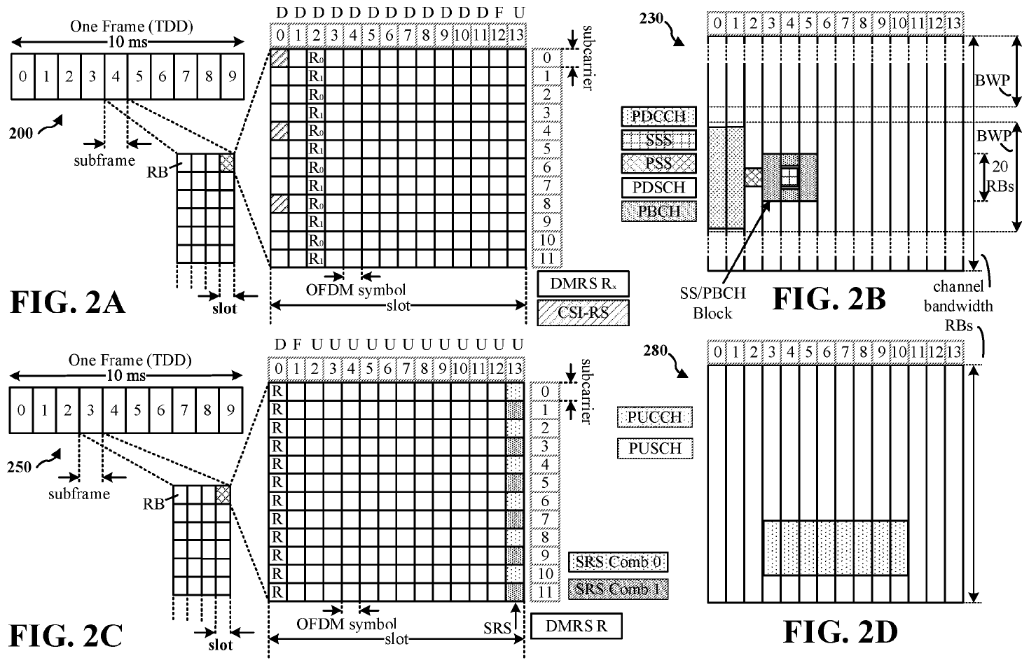

FIG. 2A is a diagram 200 illustrating an example of a first subframe within a 5G NR frame structure. FIG. 2B is a diagram 230 illustrating an example of downlink channels within a 5G NR subframe. FIG. 2C is a diagram 250 illustrating an example of a second subframe within a 5G NR frame structure. FIG. 2D is a diagram 280 illustrating an example of uplink channels within a 5G NR subframe. The 5G NR frame structure may be frequency division duplexed (FDD) in which for a particular set of subcarriers (carrier system bandwidth), subframes within the set of subcarriers are dedicated for either downlink or uplink, or may be time division duplexed (TDD) in which for a particular set of subcarriers (carrier system bandwidth), subframes within the set of subcarriers are dedicated for both downlink and uplink. In the examples provided by FIGS. 2A, 2C, the 5G NR frame structure is assumed to be TDD, with subframe 4 being configured with slot format 28 (with mostly downlink), where D is downlink, U is uplink, and F is flexible for use between downlink/uplink, and subframe 3 being configured with slot format 34 (with mostly uplink). While subframes 3, 4 are shown with slot formats 34, 28, respectively, any particular subframe may be configured with any of the various available slot formats 0-61. Slot formats 0, 1 are all downlink, uplink, respectively. Other slot formats 2-61 include a mix of downlink, uplink, and flexible symbols. UEs are configured with the slot format (dynamically through DCI, or semi-statically/statically through RRC signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on downlink may be cyclic prefix (CP) orthogonal frequency-division multiplexing (OFDM) (CP-OFDM) symbols. The symbols on uplink may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 microseconds (μs). Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry at least one pilot, such as at least one synchronization signal, at least one reference signal (RS), etc., for the UE. In some configurations, an RS may include at least one demodulation RS (DM-RS) (indicated as Rₓ for one particular configuration, where 100× is the port number, but other DM-RS configurations are possible) and/or at least one channel state information (CSI) RS (CSI-RS) for channel estimation at the UE. In some other configurations, an RS may additionally or alternatively include at least one beam measurement (or management) RS (BRS), at least one beam refinement RS (BRRS), and/or at least one phase tracking RS (PT-RS).

FIG. 2B illustrates an example of various downlink channels within a subframe of a frame. The physical downlink control channel (PDCCH) carries DCI within one or more control channel elements (CCEs), each CCD including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit SRS. The SRS may be transmitted in the last symbol of a subframe. The SRS may have a comb structure, and a UE may transmit SRS on one of the combs. The SRS may be used by a base station for channel quality estimation to enable frequency-dependent scheduling on the uplink.

FIG. 2D illustrates an example of various uplink channels within a subframe of a frame. The PUCCH may be located as indicated in one configuration. The PUCCH carries uplink control information (UCI), such as scheduling requests (SRs), a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

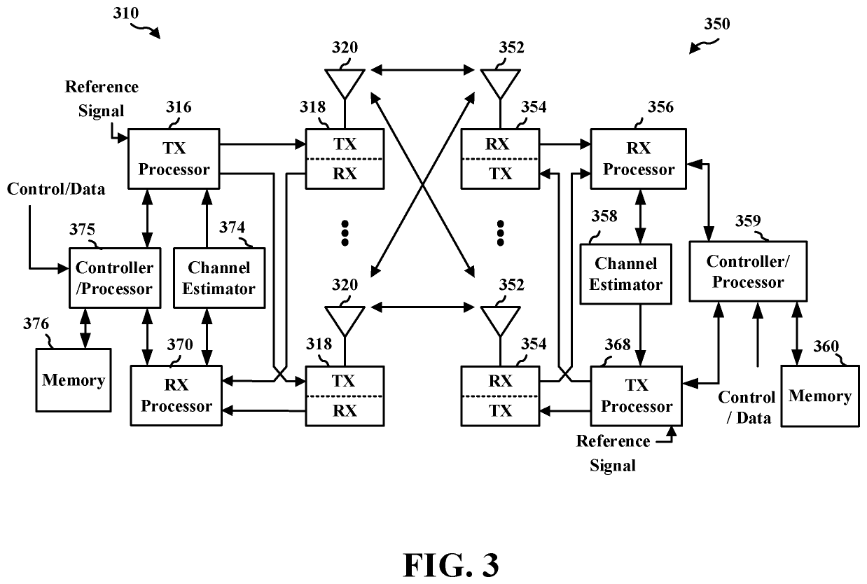

FIG. 3 is a block diagram of a base station 310 in communication with a UE 350 in an access network. In the downlink, IP packets from the EPC 160 may be provided to a controller/processor 375. The controller/processor 375 implements Layer 2 (L2) and Layer 3 (L3) functionality. L3 includes an RRC layer, and L2 includes a service data adaptation protocol (SDAP) layer, a packet data convergence protocol (PDCP) layer, an RLC layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement Layer 1 (L1) functionality associated with various signal processing functions. L1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate a radio frequency (RF) carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement L1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements L3 and L2 functionality.

The controller/processor 359 can be associated with a memory 360 that stores program codes and data. The memory 360 may be referred to as a computer-readable medium. In the uplink, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the downlink transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The uplink transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the uplink, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

In some aspects, at least one of the TX processor 316, the RX processor 370, and the controller/processor 375 may be configured to perform aspects in connection with the Sounding Configuration Component 198 of FIG. 1.

In some other aspects, at least one of the TX processor 368, the RX processor 356, and the controller/processor 359 may be configured to perform aspects in connection with the Sounding Configuration Application Component 199 of FIG. 1.

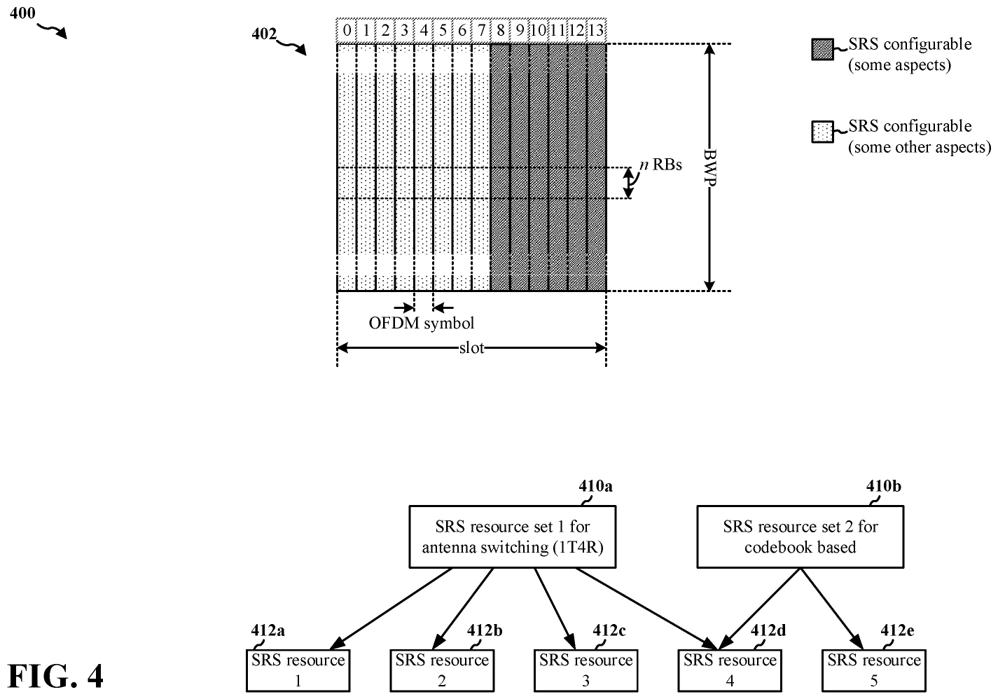

FIG. 4 is a diagram 400 illustrating example configurations of SRS resources for SRS transmission. In an access network of an example RAT, such as a 5G NR access network, a base station may estimate at least one channel on which transmissions are received from a UE (e.g., an uplink channel) using at least one SRS, which is mapped onto an SRS resource (although an SRS resource does not necessarily correspond to only one subcarrier over one symbol or an RE). The UE may transmit SRSs on one or more SRS resources, which may be included in one or more SRS resource sets.

Thus, a UE may transmit SRS to a base station (see, e.g., FIGS. 2C-2D, supra), and in so doing, some or all antenna ports of an SRS resource may be sounded in each symbol. While the UE may transmit SRS in a slot including an uplink channel (e.g., PUSCH), the SRS may sound over a wider bandwidth than the uplink channel. For example, the UE may sound all antenna ports on a wideband carrier bandwidth by transmitting SRS on SRS resources of an SRS resource set.

According to various aspects, a slot 402 may be configured to include SRSs on a set of RBs spanning a BWP. Potentially, a set of BWPs may be configured for the UE by the base station. In some aspects, a BWP may be a wideband carrier bandwidth, whereas in other aspects, the BWP may be a discrete set of contiguous subcarriers configured by the base station within a system bandwidth. Illustratively, the base station may configure 36, 48, or 64 RBs into a BWP, although different numbers of RBs are also possible for different BWPs.

A base station may signal an active BWP (e.g., the sounding BWP) to a UE, e.g., as part of an SRS configuration. In some aspects, the base station may signal the BWP and/or other information associated with SRS configuration to the UE via RRC signaling. In some other aspects, the base station may signal the BWP and/or other SRS configuration information using DCI (e.g., information included in DCI and/or a DCI Format) and/or a MAC control element (CE).

In the time domain, the slot 402 may be configured to support SRS resources that span a certain number of symbols, which may be adjacent (e.g., 1, 2, or 4 adjacent symbols) with up to 4 antenna ports per SRS resource. According to some aspects, an SRS may only be transmitted in the last six symbols of the slot 402 (e.g., the 5G NR Release 15 and/or 16 standards promulgated by the Third Generation Partnership Project (3GPP) may support SRS transmission in the last six symbols of a slot). According to some other aspects, however, an SRS resource may be configured in other symbols of a slot, in addition or alternative to the last six symbols (e.g., 5G NR Release 17 and standards from 3GPP may support SRS transmission in more than the last six symbols of a slot, such as all symbols of a slot).

In some aspects, the SRS may be transmitted in a slot after uplink data of that slot, such as uplink data carried on a PUSCH. For example, a PUSCH may be mapped to a subset of the symbols 0 through 13 of the slot 402. Next, the SRS may be mapped to a subset of the remaining symbols of the slot 402—e.g., the SRS may be mapped to 1, 2, or 4 adjacent symbols within symbols 8 through 13 of the slot 402.

In order to transmit on SRS resources, the SRS resources may be included in an SRS resource set for a UE. An SRS resource set contains sets of SRS resources on which one UE transmits. The UE may be configured with multiple SRS resources, which may be grouped in an SRS resource set. Illustratively, a UE may be configured with SRS resource set 1 410a and/or SRS resource set 2 410b.

An SRS resource set may be configured to include one SRS resource or a group of multiple SRS resources, with the SRS resource(s) included therein being based on the use case for which the SRS is transmitted, such antenna switching, codebook-based, non-codebook-based, beam management, and the like. Illustratively, for SRS antenna switching use cases, 1 or 2 TX to 2 or 4 RX antenna switching may be supported, which may be denoted as “1T2R,” “2T4R,” “1T4R,” and “1T4R/2T4R” where a UE supports both 1 TX to 4 RX and 2 TX to 4 RX antenna switching (however, antenna switching in which the numbers of TX and RX are equal may also be supported).

To support antenna switching, an SRS resource set may be configured with two (for 1T2R or 2T4R) or four (for 1T4R) SRS resources transmitted in different symbols. Each SRS resource may include one (for 1T2R or 1T4R) or two (for 2T4R) antenna port(s). The SRS antenna port(s) of each SRS resource may be associated with different UE antenna port(s).

The preceding antenna switching configurations are to be regarded as illustrative and non-limiting. The present disclosure comprehends additional or alternative aspects in which other numbers of SRS resources are configured in an SRS resource set, e.g., in order to support xTyR antenna implementations in which x may be an integer inclusively within the range of one to four and y may be an integer inclusively within the range of one to eight. For example, antenna switching configurations of 1T6R and/or 1T8R may be supported.

As shown in one example of FIG. 4, the SRS resource set 1 410a is based on 1T4R, and therefore includes four SRS resources 1 through 4 412a-d. The four SRS resources 1 through 4 412a-d may occur in one slot, such as within four adjacent symbols indexed 8 through 13 of the slot 402. However, other configurations may also be supported. For example, for 1T4R, two aperiodic SRS resource sets may be configured with a total of four SRS resources for transmission in different symbols of two different slots, instead of SRS resources 1 through 4 412a-d in one slot.

As further illustrated by FIG. 4, the SRS resource set 2 410b may be based on a use case of codebook-based transmission (e.g., for beamforming), such as when feedback of precoding information (e.g., PMI) and/or other information is configured to increase throughput at the receiver side (e.g., base station). The SRS resource set 2 410b may include SRS resource(s) based on codebook-based transmission, such as one SRS resource 5 412e or two SRS resources SRS resource 4 412d and SRS resource 5 412e. In some aspects, an SRS resource set (e.g., SRS resource set 2 410b) may be wideband in that the SRS resource(s) of the SRS resource set span the full SRS bandwidth (e.g., wideband carrier bandwidth) in a symbol.

Scheduling of SRS transmission may be periodic, semi-persistent, or aperiodic. Accordingly, a UE may be configured for aperiodic, semi-persistent, or periodic transmission of an SRS resource set. For aperiodic transmission of an SRS resource set, a base station may trigger SRS transmission by a UE via some signaling, such as DCI. In some aspects, two (2) bits in DL or UL DCI may trigger SRS transmission on SRS resources of an SRS resource set.

For example, a base station may transmit DCI to a UE that includes a field designated as an “SRS request” field, and such a field may include a value (e.g., two bits) triggering SRS transmission by a UE. In some instances, the base station may indicate an SRS resource set that the UE is to use for SRS transmission. Illustratively, the UE may be configured with one or more SRS resource sets for aperiodic SRS transmission, and each of the SRS resource sets may be associated with a respective value or other identifier, such as 1, 2, or 3. When the base station triggers SRS transmission by the UE, the base station may signal the respective value or other identifier corresponding to one of the SRS resource sets that the UE is to use for aperiodic SRS transmission.

In order to trigger the UE to use one SRS resource set, the base station may first configure the UE with the one or more SRS resource sets. The base station may transmit information configuring each of the one or more SRS resource sets to the UE via RRC signaling. In some aspects, each SRS resource set is configured via RRC signaling with two parameters, a first of which may identify the SRS resource set that the UE is to use for SRS transmission and a second of which may identify additional SRS resource set(s) that the UE may potentially use for SRS transmission.

In the context of some RATs, such as 5G NR, each of the first and second parameters may be included in one or more RRC messages as a respective field of an information element (IE), such as an SRS-Config IE. The first parameter may be associated with a field labeled aperiodicSRS-ResourceTrigger and may have a value of 1, 2, or 3, whereas the second parameter may be associated with a field labeled aperiodicSRS-ResourceTriggerList and may indicate an array of two values. Each value of the aforementioned fields may be referred to as a “code point” or a “DCI code point.”

By way of illustration, Table 1 illustrates potential code points that configure aperiodic SRS transmission using SRS resource set(s). Specifically, the code points may be conveyed as one of the following values in an SRS request field of DCI.

TABLE 1

| | Triggered aperiodic SRS | Triggered aperiodic SRS |
|---|---|---|
| | resource set(s) for DCI | resource set(s) for DCI |
| | format 0_1, 1_1, and 2_3 | format 2_3 configured |
| | configured with higher | with higher layer |
| | layer parameter srs-TPC- | parameter srs-TPC- |
| Value of SRS | PDCCH-Group set to | PDCCH-Group set to |
| request field | ‘typeB’ | ‘typeA’ |
| 00 | No aperiodic SRS resource | No aperiodic SRS resource |
| | set triggered | set triggered |
| 01 | SRS resource set(s) | SRS resource set(s) |
| | configured with higher | configured with higher |
| | layer parameter | layer parameter usage in |
| | aperiodicSRS- | SRS-ResourceSet set to |
| | ResourceTrigger set to 1 | ‘antennaSwitching’ and |
| | or an entry in | resourceType in SRS- |
| | aperiodicSRS- | ResourceSet set to |
| | ResourceTriggerList set to | ‘aperiodic’ for a 1^{st} set of |
| | 1 | serving cells configured by |
| | | higher layers |
| 10 | SRS resource set(s) | SRS resource set(s) |
| | configured with higher | configured with higher |
| | layer parameter | layer parameter usage in |
| | aperiodicSRS- | SRS-ResourceSet set to |
| | ResourceTrigger set to 2 | ‘antennaSwitching’ and |
| | or an entry in | resourceType in SRS- |
| | aperiodicSRS- | ResourceSet set to |
| | ResourceTriggerList set to | ‘aperiodic’ for a 2^{nd} set of |
| | 2 | serving cells configured by |
| | | higher layers |
| 11 | SRS resource set(s) | SRS resource set(s) |
| | configured with higher | configured with higher |
| | layer parameter | layer parameter usage in |
| | aperiodicSRS- | SRS-ResourceSet set to |
| | ResourceTrigger set to 3 | ‘antennaSwitching’ and |
| | or an entry in | resourceType in SRS- |
| | aperiodicSRS- | ResourceSet set to |
| | ResourceTriggerList set to | ‘aperiodic’ for a 3^{rd} set of |
| | 3 | serving cells configured by |
| | | higher layers |

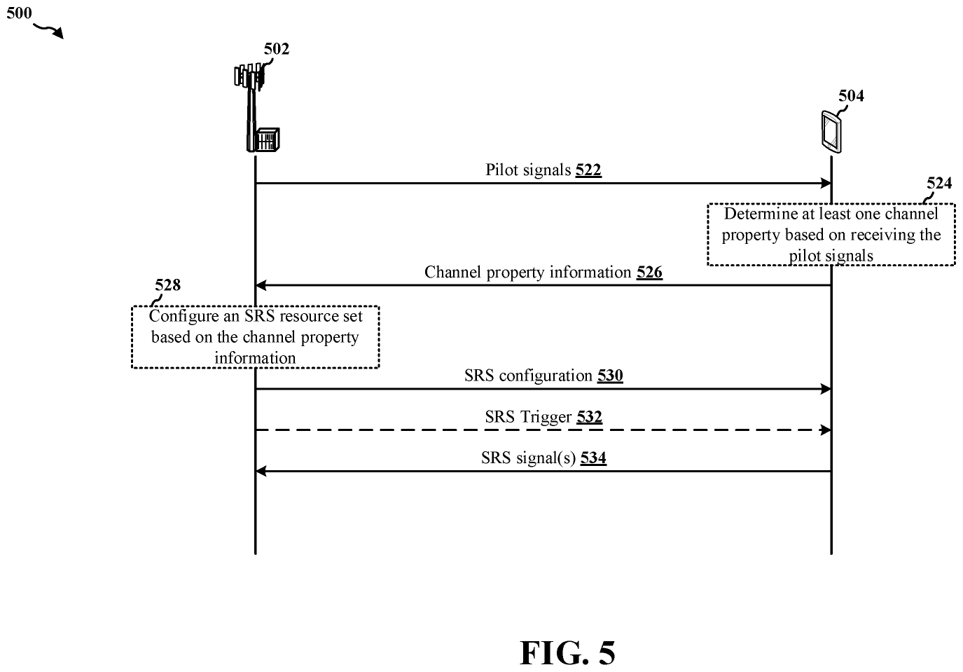

FIG. 5 is a call flow diagram 500 illustrating example operations and communications flow for an SRS transmission that is configured using UE-reported information. The base station 502 and the UE 504 may communicate on a wireless channel, which may be characterized as a discrete set of frequency divisions (e.g., one on the uplink and the other on the downlink) that is time-variant with respect to fading such that some (or all) channel properties are stochastic. In various aspects, the base station 502 may transmit pilot signals 522, which may be received by the UE 504. Pilot signals may include reference signals (e.g., CSI-RSs), tracking signals, synchronization signals (e.g., SSBs), or other reference or synchronization signals, for example, as described with respect to FIG. 2A supra.

The UE 504 may receive one or more of the pilot signals 522 when the UE 504 is within the coverage area of the base station 502, and the UE 504 may use the received pilot signals 522 for various operations related to communicating with the base station 502, such as achieving synchronization using one or more SSBs, or measuring received signal strength or evaluating channel quality using one or more CSI-RSs.

In some aspects, the base station 502 may transmit the pilot signals 522 in a mmW spectrum, such as FR2, and so the UE 504 may use the pilot signals 522 for some beamforming procedures, such as beam tracking, beam refinement, beam steering, and/or other beam management. In some other aspects, the base station 502 may transmit the pilot signals 522 in a relatively lower spectrum, such as FR1 or another sub-6 or sub-7 GHz spectrum. The UE 504 may use the pilot signals 522 for various procedures, such as synchronization and channel estimation. Accordingly, the UE 504 may determine 524 at least one channel property based on receiving the pilot signals 522. Specifically, as the UE 504 receives one or more of the pilot signals 522, the UE 504 may measure, compute, or otherwise determine respective sets of channel properties across the antenna ports used to communicate with the base station 502.

Such channel properties may include, inter alia, at least one of a Doppler shift(s), Doppler spread(s), average delay(s), delay spread(s), and/or spatial filter parameter(s). Each of the preceding channel properties may be derivable from a subset of the set of pilot signals 522. In some implementations, the UE 504 may determine 524 at least one Doppler shift and/or delay spread corresponding to at least one antenna port using one or more of the pilot signals 522. For example, the UE 504 may determine 524 at least one Doppler shift associated with at least one antenna port by measuring a shift in the frequency of a signal component of the pilot signals 522 on one of the antenna ports. In some further implementations, the UE 504 may determine 524 a Doppler shift and/or delay spread for each antenna port the corresponds to an SRS resource of an SRS resource set.

In another example, the UE 504 may determine 524 the Doppler spread with respect to a given time according to the difference between at least two Doppler shifts of at least two signal components as received by the UE 504. The Doppler spread may also be known as the fading rate, and may be inversely proportional to the coherence time. In some further implementations, the UE 504 may determine 524 a Doppler spread from at least two Doppler shifts for each antenna port that corresponds to an SRS resource of an SRS resource set (either with or without determination of a delay spread).

In a further example, the UE 504 may determine at least one delay spread in order to obtain a multipath profile of a channel. In one implementation, the UE 504 may determine 524 at least one delay spread by calculating a quotient of the velocity of the UE 504 (which may be a function of UE mobility) and the wavelength of a received one of the pilot signals. In another implementation, the UE 504 may determine 524 at least one delay spread by calculating a difference between the time of arrival of the earliest (significant) multi-path signal component (e.g., often the line-of-sight component) and the time of arrival of the latest (significant) multipath signal component.

While the UE 504 may determine 524 the aforementioned channel properties on the downlink, one or more of these channel properties may be applicable to (or otherwise informative of) channel properties in the reverse direction (e.g., uplink) as well. Specifically, TDD channel reciprocity may be maintained between the uplink and downlink channels, at least to a degree at which some of the channel properties derived on the downlink may be informative regarding the uplink within an acceptable tolerance or margin. Therefore, such channel properties determined from pilot signals 522 on the downlink may be applied by the base station 502 for receiving signals on the uplink from the UE 504, e.g., similar to reception of downlink data (and/or control information) using channel properties determined by the UE 504 from reference signals having quasi-colocation (QCL) relationships with downlink data signals, such as with QCL Type A, B, C, or D relationships specified for the 5G NR RAT.

To that end, the UE 504 may transmit channel property information 526 to the base station 502, with such channel property information 526 indicating at least one of the aforementioned Doppler shift(s), Doppler spread(s), average delay(s), delay spread(s), and/or spatial filter parameter(s). Some mechanisms that would facilitate application and even determination of such some channel properties by the base station 502 may be absent from many wireless/radio access networks. In particular, SRS signals are not designed to function as tracking signals, further, many UEs transmitting signals to the base station 502 may have insufficient transmit powers to be useful on the scale that would be commensurate with transmission of tracking signals. Therefore, the UE 504 may be configured to supply one or more of the determined channel properties to the base station 502, which the base station 502 may use in SRS configuration for the UE 504.

In some configurations, for example, the channel property information 526 may include a respective value corresponding to each of the at least one Doppler shift, Doppler spread, and/or delay spread. In some aspects of such configurations, the channel property information 526 may include a value corresponding to at least one Doppler spread (potentially, in addition to indicating a delay spread). Though indirect, the value corresponding to a Doppler spread may function as a tacit indication of at least two Doppler shifts by virtue of the Doppler spread being the difference between at least two Doppler shifts of at least two signal components at a given time.

In some further configurations, the channel property information 526 may include one or more quantized values respectively corresponding to one or more of the delay spread(s) and/or Doppler shift(s) (e.g., either directly or indirectly through the Doppler spread(s)). The UE 504 may be configured to determine 524 the at least one channel property and, upon such determination, the UE 504 may quantize the at least one channel property, such as by assigning a measured or calculated value to one of multiple comparators (e.g., as with “low,” “medium,” and “high”), representative values (e.g., as with rounding to the nearest integer).

The UE 504 may transmit, to the base station 502, the quantized value in the channel property information 526, and the UE 504 may omit the actual values determined for the channel properties. In other words, in some aspects, the UE 504 may refrain from transmitting measured values corresponding to Doppler shift(s), Doppler spread(s), and delay spread, and instead the UE 504 may transmit quantized values representative of such measured values.

In some other configurations, the UE 504 may transmit channel property information 526 that implicitly indicates a channel property through one of a recommendation or request for a certain SRS configuration that the UE 504 determines is suitable for the measured channel properties of the wireless channel. In still other configurations, the UE 504 may transmit information indicating a UE mobility state of the UE 504, such as a speed or velocity of the UE 504, which may implicitly indicate one or more channel properties, either alone or when taken in combination with some other information, such as a position or other geographic location of the UE 504. Potentially, the UE 504 may exclude some or all of the raw data values (e.g., measured values) and/or processed data values (e.g., quantized values) from the channel property information 526, such as when the channel property information includes a recommendation or request for an SRS configuration.

As wireless channels are time-variant fading channels, UE mobility may affect signals on the wireless channel on which communication with the base station 502 is configured. Therefore, the UE may determine 524 a recommendation based on a mobility status or speed (e.g., velocity) of the UE 504, which may be indicative of the set of channel properties in that the recommendation may be more tailored toward some dominant factors contributing to signal attenuation and less so toward other attenuation factors that may contribute to signal loss on the channel to a negligible or correctable degree. As the UE 504 may derive such a recommendation based upon the channel properties, the recommendation may implicitly indicate one or more of the channel properties. For example, the UE 504 may recommend an SRS configuration that leverages time diversity (e.g., interleaving, error-correcting code, etc.) when the wireless channel is fast-fading and the coherence time is relatively short (e.g., in relation to symbol duration). In another example, the UE 504 may recommend an SRS configuration that leverages frequency diversity (e.g., as with diversity receivers, equalizers, etc.) when the wireless channel is selective-fading and the coherence time is longer.

In some aspects, SRS resources of a set may be configured with a frequency comb size, as a function of the base station 502 configuring SRS resources on a frequency comb structure having a comb size that defines the frequency spacing for each SRS signal—that is, the comb size defines the number of subcarriers one RE with an SRS signal is separated from another RE with an SRS signal in the same symbol. For example, the comb size may be configured as one of a set of enumerated values, e.g., (2, 4, 6, 8, 10, 12), with the number of SRS in each slot being inversely proportional to the ascending enumerated values. Additionally or alternatively, the SRS resources of a set may be configured with a cyclic shift (CS) distance (or CS difference), and/or a time-domain symbol number (e.g., an index of a symbol of a slot an SRS resource is configured to include). One or more of the aforementioned configurations may be so configured based on at least one of the properties of the wireless channel, such as Doppler spread (e.g., including Doppler shifts) and/or delay spread, as the at least one of the channel properties may effectively disallow some diversity schemes or other configurations.

In some instances, the delay spread of signaling on the fading channel, which may be commensurate with a relatively short subsymbol duration, may be prohibitive of various spatial diversity schemes, but not other diversity schemes, error correction (or detection) coding, and/or other configurations applied for avoidance of undesirable phenomena on the wireless channel. For some instances in which the subsymbol duration is relatively shorter, the UE 504 may recommend to the base station 502 that SRS transmission by the UE 504 be configured with a time-domain orthogonal cover code (OCC) (TD-OCC), which may include application on one reference symbol of a code (e.g., cover code or other pattern) that is mutually orthogonal to at least one other code applied to another reference symbol, and the two reference symbols may be consecutive. TD-OCC may be suitable for the frequency selectivity corresponding to the relatively larger delay spread, for example, as TD-OCC may provide some level of diversity gain with symbol repetitions.

In some other instances, the Doppler spread may be relatively large, implying a relatively short coherent time and correlated with increased time selectivity on the fading channel. Consequently, some schemes for time diversity may be predicated upon a number of symbol repetitions in the time domain that is unsupported or unsatisfactory. For some instances in which the delay spread is relatively large (and/or the subsymbol duration is relatively shorter), the UE 504 may recommend a frequency domain OCC (FD-OCC), which may include application on one reference subcarrier of a code (e.g., cover code or other pattern) that is mutually orthogonal to at least one other code applied to another reference subcarrier, which may be adjacent to the one subcarrier having the mutually orthogonal code applied thereto.

For some other instances in which the delay spread is relatively large, the UE 504 may recommend cyclic shifts separated by at least a certain distance, which may be used in addition or in alternative to the abovementioned FD-OCC, e.g., to increase the SRS capacity and/or maintain orthogonality across SRS signals with respect to auto-correlation and/or cross-correlation. Further, the UE 504 may recommend a comb size that is relatively smaller in order to control the frequency spacing of some signaling (and by extension, control signal the number of signals multiplexed in the same symbol) in a manner that is suitable for the frequency selectivity corresponding to the relatively larger delay spread.

In still other instances, the UE 504 may determine at least one of the channel properties may be especially variant or stochastic, and/or the UE 504 may determine that communication on the wireless channel should be feature additional robustness and flexibility. In such instances, the UE 504 may recommend that the base station 502 configure SRS transmission for the UE 504 to include cover codes in two dimensions. For example, the UE 504 may recommend, to the base station 502, TD-OCC for time domain dimensionality and FD-OCC (and/or CS) for frequency domain dimensionality. In another example, the UE 504 may recommend, to the base station 502, two-dimensional DFT-based codes for application of cover codes having dimensionality in the time and frequency domains to SRS transmissions.

Correspondingly, the base station 502 may receive the channel property information 526 from the UE 504 based on the set of pilot signals 522 transmitted on the wireless channel. The base station 502 may configure 528 at least one SRS resource and at least one SRS resource set based on the received channel property information 526. In some aspects in which the channel property information 526 includes at least one measured value (or other raw data) corresponding to at least one delay spread, Doppler shift, or Doppler spread, the base station 502 may compare the measured value within at least one threshold. If the base station 502 determines that the measured value satisfies (e.g., meets or exceeds) the at least one threshold, then the base station 502 may configure 528 the at least one SRS resource and SRS resource set accordingly. For example, if the measured value satisfies at least one threshold that is indicative of a large delay spread, then the base station 502 may configure 528 the at least one SRS resource with TD-OCC and, potentially, may refrain from configuring the at least one SRS resource with FD-OCC and CS.

In some other aspects, the base station 502 may compare the measured value to at least two thresholds in order to identify a range or category to which the measured value corresponds, such as a category of “high” Doppler spread or a category of “low” delay shift. The base station 502 may then configure 528 at least one SRS resource and SRS resource set according to the identified range or category.

Similarly, where the channel property information 526 includes information indicating a quantized value, the base station 502 may configure 528 at least one SRS resource and SRS resource set according to the quantized value, which may be in the form of a category when received by the base station 502 or the base station 502 may categorize the quantized value based on comparison with at least one threshold. For example, if the channel property information 526 includes information indicating that the Doppler spread is high and/or the UE 504 is traveling at a high velocity (e.g., away from the base station 502), then the base station 502 may configure 528 the at least one SRS resource with FD-OCC and/or CS. If the channel property information 526 does not also indicate that the delay spread is high, the base station 502 may refrain from configuring the at least one SRS resource with TD-OCC.

In some further aspects, where the channel property information 526 includes a recommendation that is indicative of a channel property value, the base station 502 may configure at least one SRS resource and SRS resource set based on the recommendation. For example, the base station 502 may accept the recommendation and configure 528 the at least one SRS resource and SRS resource set according to the recommendation. Alternatively, the base station 502 may reject the recommendation, and instead, the base station 502 may configure 528 the at least one SRS resource and SRS resource set according to information different from and/or in addition to the recommendation.

The base station 502 may then transmit an SRS configuration 530 to the UE 504 to inform the UE 504 of the at least one SRS resource and at least one SRS resource set configured by the base station 502. The UE 504 may accordingly receive the SRS configuration 530 from the base station 502, e.g., via RRC signaling or via other signaling. In this way, the UE 504 may be informed of the SRS resources on which to transmit SRS signals with one or more schemes applied thereto for various SRS resource sets.

Having received the SRS configuration 530 from the base station 502, the UE 504 may transmit at least one SRS signal 534 on the SRS resource configured for the SRS resource set. If the UE 504 is configured for aperiodic SRS transmission, the base station 502 may transmit an SRS trigger 532 to the UE 504 instructing the UE 504 to sound over some or all ports. The SRS trigger 532 may be included in DCI or other control information.

In order to do transmit the at least one SRS signal 534, the UE 504 may apply the one or more schemes configured by the base station 502 for SRS transmission. For example, the UE 504 may apply one or more of TD-OCC, FD-OCC, cyclic shifting, and or a comb to the at least one SRS signal 534 according to the received SRS configuration 530. Where the UE 504 applies a TD-OCC, the UE 504 may apply the TD-OCC across at least two symbols of one subcarrier. Where the first OCC is an FD-OCC, the UE 504 may apply the FD-OCC across at least two subcarriers of one symbol.

In some aspects, the UE 504 may apply a DFT code having a frequency-domain dimension and a time-domain dimension to the at least one SRS signal. The at least one SRS configuration 530 may include information indicating a basis from which orthogonal sequences can be derived, and each sequence may be used to sound different ports of the UE 504. The bases and sequences may be based on oversampling by a certain factor in the time domain and the frequency domain. Accordingly, the number of bases may be based on the oversampling factor. The base station 502 may allocate other sequences, which may be non-orthogonal with the sequences generated by the UE 504.

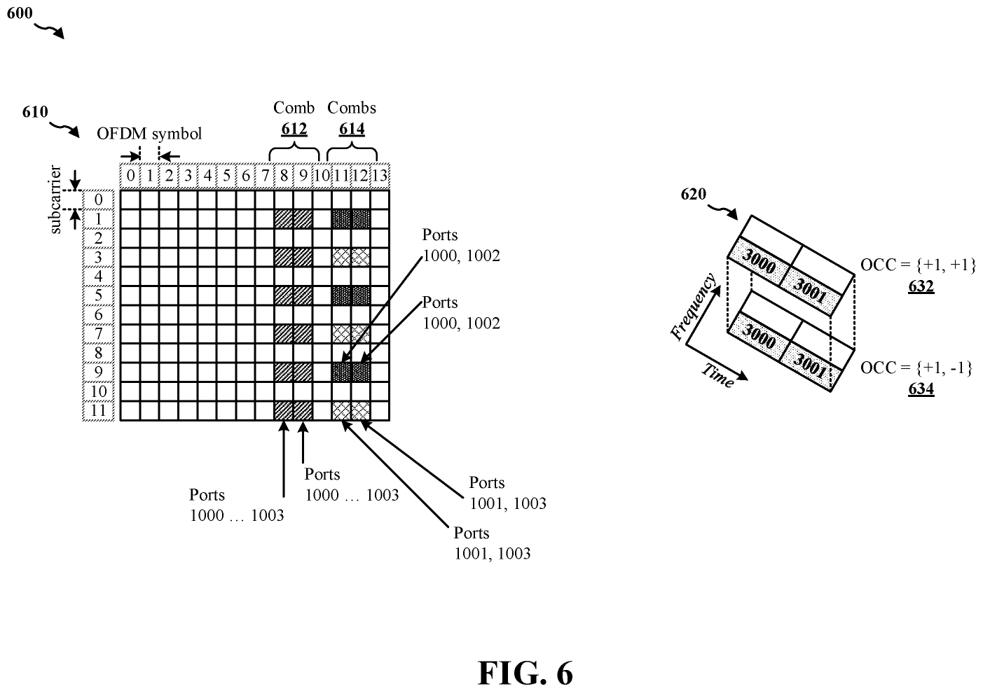

FIG. 6 is a diagram 600 illustrating an example cover code that may be applied for SRS transmission. A base station may configure an SRS resource of an SRS resource set, which may correspond to a mapping 610 onto a set of subcarriers in at least one slot. The base station may configure a UE with the SRS resource in at least one SRS resource set, and the UE may then transmit SRS signaling according to the mapping 610 indicated by the SRS configuration. In the context of FIG. 5, for example, the base station 502 may transmit the SRS configuration 530 to the UE 504 in order to configure the UE 504 with the SRS resource for SRS transmission.

The UE may sound over ports of the SRS resource, such as by transmitting a signal on the SRS resource. In the illustrated aspects, the SRS resource may include two ports (e.g., when antenna switching is 2T2R, 2T4R, etc.), which may have a port number inclusively between 1000 and 1003. In the context of FIG. 5, for example, the UE 504 may transmit the SRS signal(s) 534 according to the SRS configuration 530.

In some aspects, an SRS resource may be configured to include a comb structure in which the SRS transmission is mapped on to non-contiguous subcarriers. In one configuration, an SRS resource may be configured with a comb spacing equal to two, and therefore, the UE may map SRS transmission of the SRS resource onto one comb 612 to sound over every port on every other subcarrier in the configured symbols of the slot.

In another configuration, the SRS resource may be configured with two combs 614, with one pair of ports, such as (1000, 1002), being configured on subcarriers of one comb and another pair of ports, such as (1001, 1003), being configured on subcarriers of another comb. The combs 614 may be non-overlapping in the frequency domain, such as where each of the combs 614 has a spacing equal to four. Thus, the UE may map SRS transmission on each pair of ports onto every fourth subcarrier in the configured symbols of the slot. For example, the SRS transmission on ports (1000, 1002) may be mapped onto every fourth subcarrier beginning with an offset of one, and so the SRS transmission on ports (1000, 1002) may sound over every fourth subcarrier beginning with subcarrier index 1. Similarly, the SRS transmission on ports (1001, 1003) may be mapped onto every fourth subcarrier beginning with an offset of four, and so the SRS transmission on ports (1001, 1003) may sound over every fourth subcarrier beginning with subcarrier index 3 without adversely affecting the SRS transmission on (1000, 1002).

Comb structures may increase multi-UE capacity to some degree by multiplexing multiple UEs in the frequency domain, as shown, and may be suitable in some instances (potentially, with CS being applied as well), such as where the delay spread is relatively large. However, some orthogonality in the time domain may be absent. As described herein, however, TD-OCCs may be used for SRS transmission in order to improve signal reliability in instances where CS, FD-OCC, or comb structures are insufficient to counteract the Doppler spread and/or a greater number of users are to be multiplexed in the same slot.

In order to increase multiplexing capacity and mitigation signal fading effects of the Doppler spread, TD-OCC may be applied to SRS transmission on each of the REs 620 onto which an SRS resource is mapped. With TD-OCC, two or more ports may be multiplexed according to code-division multiplexing (CDM) using an OCC over two (or more) symbols. For example, two ports (3000, 3001) may be multiplexed using OCC {+1, +1} 632 and OCC {+1, −1} 634 over two symbols and mapped onto two different REs having a subcarrier in common but not a symbol (although the symbols may be consecutive). Illustratively, in a first RE 622, (port 1+a port 2) is transmitted, whereas in the second RE 624, (port 1−port 2) is transmitted. With application of a TDD-OCC, the number of layers for SRS transmissions may be increased (e.g., rank 2) while maintaining orthogonality. While the present disclosure describes some OCC of length 2, OCC of different length(s) may be used without departing from the scope of the present disclosure.

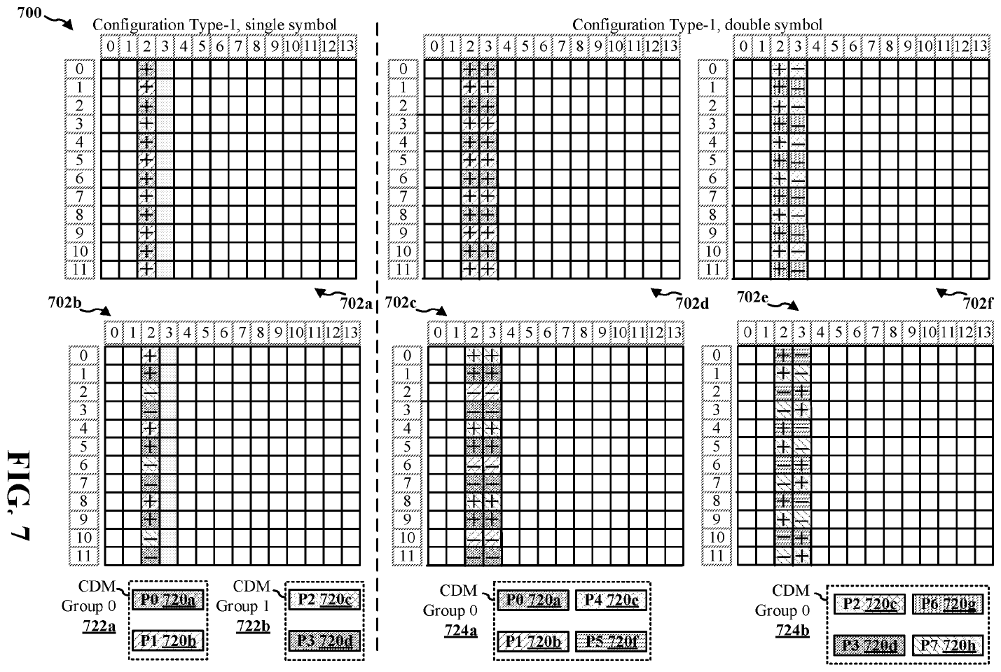

FIG. 7 is a diagram 700 illustrating an example of a cover code applied for transmission of pilot signals. Pilot signals 720 may be transmitted on different ports, e.g., numbered 0 through 3 or numbered 0 through 7, with two transmission layers configured to be orthogonal The pilot signals 720 may be separated into different CDM groups 722, 724. CDM groups 722, 724 may include REs for which TD-OCC is applied.

In a first configuration, two layers 702a, 702b (e.g., rank 2) may be supported while orthogonality is maintained. Each slot carries one of the pilot signals 720 in one symbol. Port-0 pilot signals 720a and port-1 pilot signals 720b may be grouped together in a first CDM group 722a, whereas port-2 pilot signals 720c and port-3 pilot signals 720d may be grouped together in a second CDM group 722b.

In a second configuration, four layers 702a, 702b, 702c, 702d (e.g., rank 4) may be supported while orthogonality is maintained. Each slot carries two of the pilot signals 720 in two symbols. Port-0 pilot signals 720a, port-1 pilot signals 720b, port pilot signals 4 720e, and port 5 pilot signals 720f may be grouped together in a first CDM group 724a, whereas port-2 pilot signals 720c, port-3 pilot signals 720e, port 6 pilot signals 720g, and port 7 pilot signals 720h may be grouped together in a second CDM group 724b.

In each configuration, each port may be unique via a CDM group and OCC. The use of OCC over multiple symbols may maintain orthogonality across multiple layers with less susceptibility to fading effects of the Doppler spread.

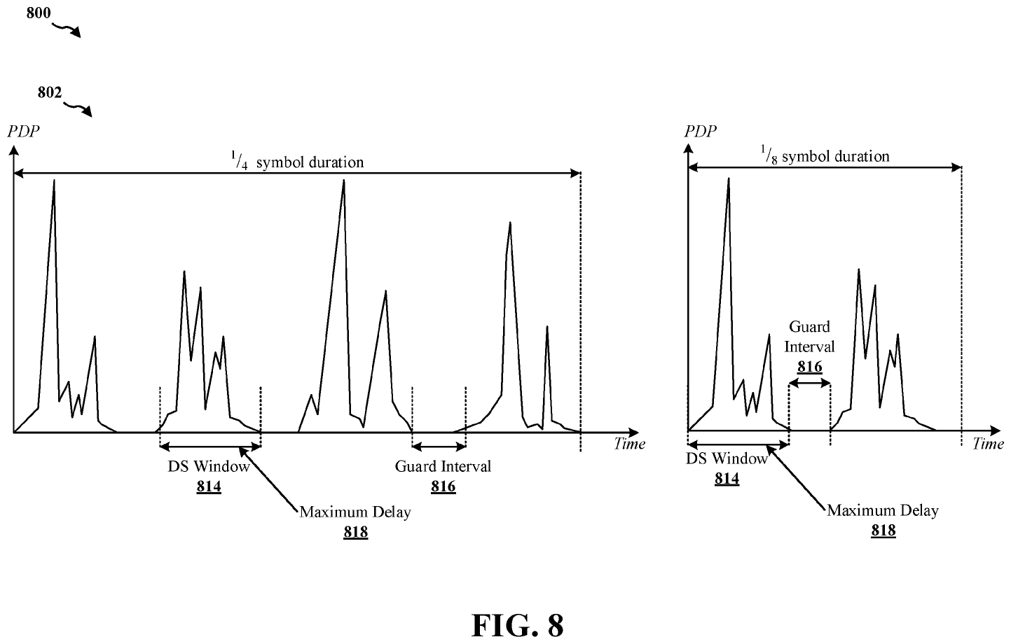

FIG. 8 is a diagram 800 illustrating an example of delay spread for signals on transmission combs with CS applied. In the first graph 802, the power delay profile (PDP) of signals configured on a comb 4 (e.g., signal on one symbol every four subcarriers) and may be transmitted with multiple cyclic shifts. A maximum delay 818 may be the delay between the first received (significant) multipath signal component and the last received multipath signal component.

If the maximum delay 818, corresponding to a delay spread window 814 of the channel properties, were to increase outside the guard interval 816 afforded by the CS of the signal (and aided by the transmission comb), then different multipath components may begin to bleed into the guard interval 816 and eventually overlap. Such overlap may result in inter-symbol interference, leading to performance loss. The available CS depends on the maximum delay 818; however, relatively larger delays may be necessary in order for relatively large CS differences and relatively small comb size to be supported. In some instances, the delay spread may not be as significant as the Doppler spread in terms of signal transmission. Therefore, large CS differences and small comb size may not be supported when the Doppler spread is the predominant component of signal attenuation. Instead, TDD-OCC may be applied to mitigate some fading on the wireless channel. As UE mobility may affect the Doppler spread—e.g., the Doppler spread may increase as UE mobility state also increases in terms of spread or velocity.

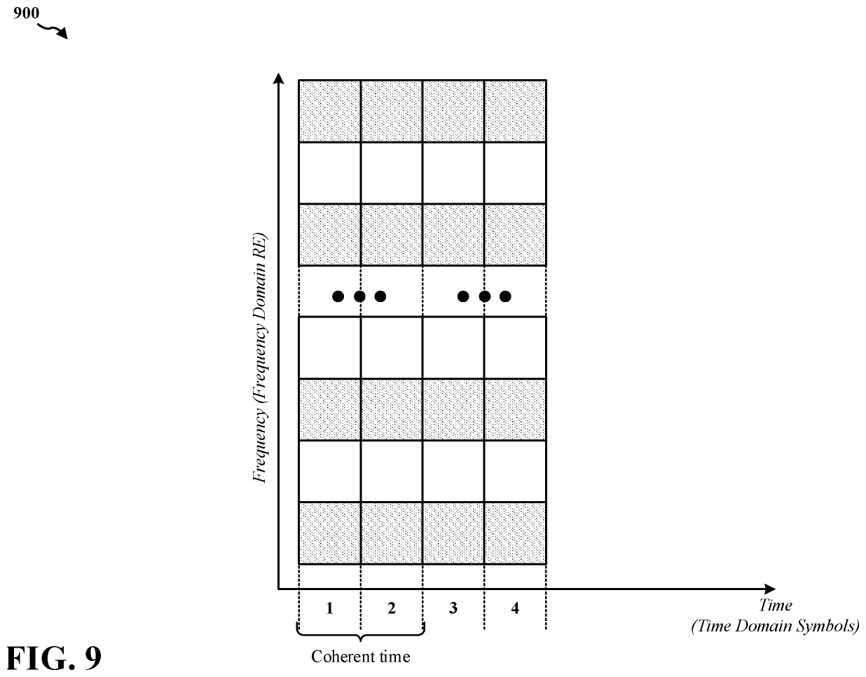

FIG. 9 is a diagram 900 illustrating an example of code size configuration for TD-OCC used with SRS. In wireless communication systems, the coherence time may be characterized as the duration over which a channel impulse response of a time-variant channel can be treated as invariant.

For high mobility UEs, as well as some or all moderate mobility UEs, the coherence time may be appreciably shorter than that of low mobility UEs, and in particular, stationary UEs. This difference arises as a consequence of the Doppler effect, which is magnified at increased speeds. As an increasing Doppler spread correspondingly reduces the duration that an impulse response of a wireless channel can be regarded as invariant, the coherence time is inversely proportional to the Doppler spread.

In the context of TD-OCC, the number of symbol repetitions that can be supported by the channel properties may be a function of the coherence time, and so may affect the number of layers or transmission rank supported through application of TD-OCC. As illustrated, the coherence time T, may be 2 symbols; T, <3 symbols, and consequently, TD-OCC code sizes of three or more may be unsupported given the UE mobility state (e.g., high) and the Doppler spread. That is, TD-OCC code sizes of one and two may be the supported code sizes, as the coherence time may be approximately two symbols given the Doppler effect on the wireless channel between the base station and the UE.

In the context of FIG. 5, the UE 504 may determine 524 the at least one channel property by determining the Doppler spread over a set of pilot signals 522 received from the base station 502. The UE 504 may then report channel property information 526 indicating the determined Doppler spread to the base station 502. Therefore, the base station 502 may be informed of the supported TD-OCC code size(s) for the UE 504, and the base station 502 may configure 528 SRS resources of an SRS resource set for the UE 504 according to the reported Doppler spread.

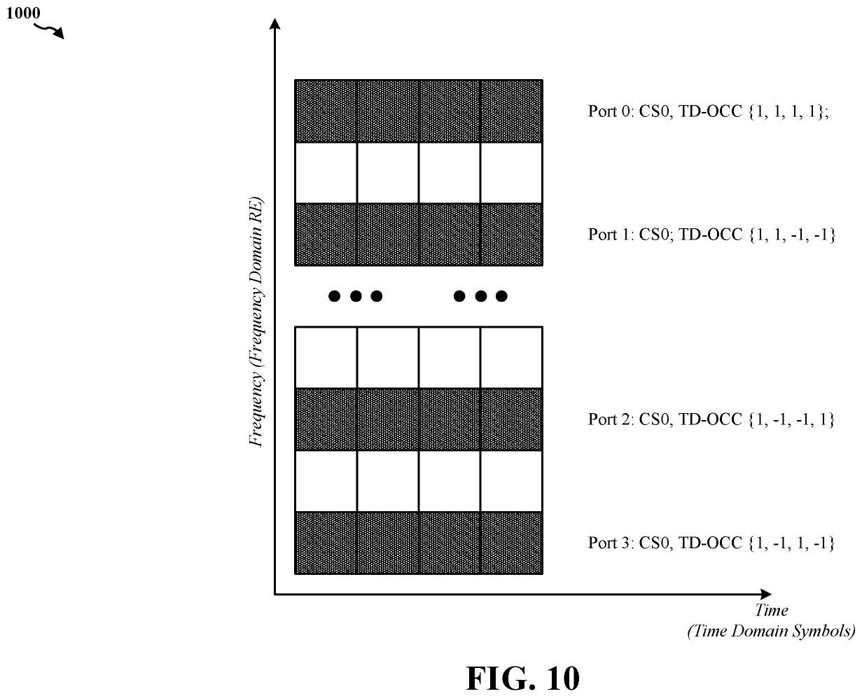

FIG. 10 is a diagram 1000 illustrating an example of a cover code for an SRS resource in the time domain. A UE may include four ports over which to sound using an SRS resource of an SRS resource set. The SRS resource may be configured on a comb-two structure. In the time domain, the UE may be configured to sound four ports using TD-OCC having a code size of four across four symbols in the time domain. In the frequency domain, the UE may use one Zadoff-Chu (ZC) sequence to sound all four ports. However, the same cyclic shift may be used when sounding all four ports.

As the TD-OCC may be different across the four ports, orthogonality may be maintained. Absent the TD-OCC, orthogonality may be absent when SRS transmission on all four ports uses the same non-shifted ZC sequence. In some aspects, a base station may configure a UE for sounding with SRS resources on which to apply TD-OCC but not CS in instances in which the UE is experiencing a relatively large delay spread and/or has a low or stationary UE mobility state.

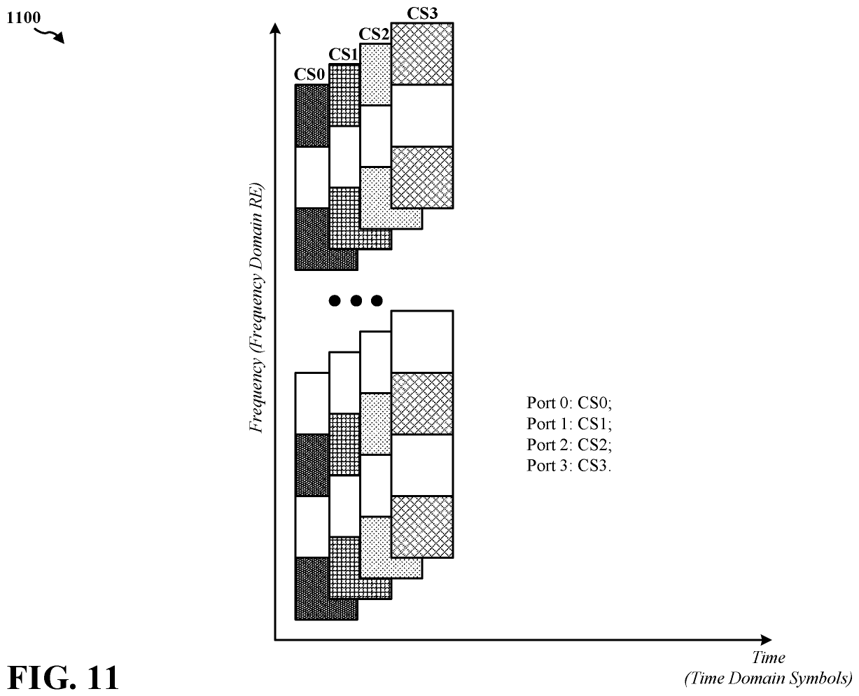

FIG. 11 is a diagram 1100 illustrating an example of a cover code for an SRS resource in the frequency domain. A UE may include four ports over which to sound using an SRS resource of an SRS resource set. The SRS resource may be configured on a comb-two structure. In the frequency domain, the UE may use one ZC sequence to sound all four ports, with the ZC sequence being differently shifted on each of the four ports. In the time domain, however, all the ports may be multiplexed onto one symbol.

As a different CS number may be used to shift each ZC sequence across each of the four ports, orthogonality may be maintained, even where all four ports are multiplexed in one symbol. Differently shifting each ZC sequence may be sufficient for a base station to differentiate between SRS transmissions multiplexed onto one symbol. In some aspects, the base station may configure a UE for sounding with SRS resources on which to apply CS (and/or another FD-OCC) in instances in which the UE is experiencing a relatively small delay spread and/or has a high or moderate UE mobility state, e.g., in which the Doppler spread has reduced the coherence time to an insufficient or unsatisfactory duration.

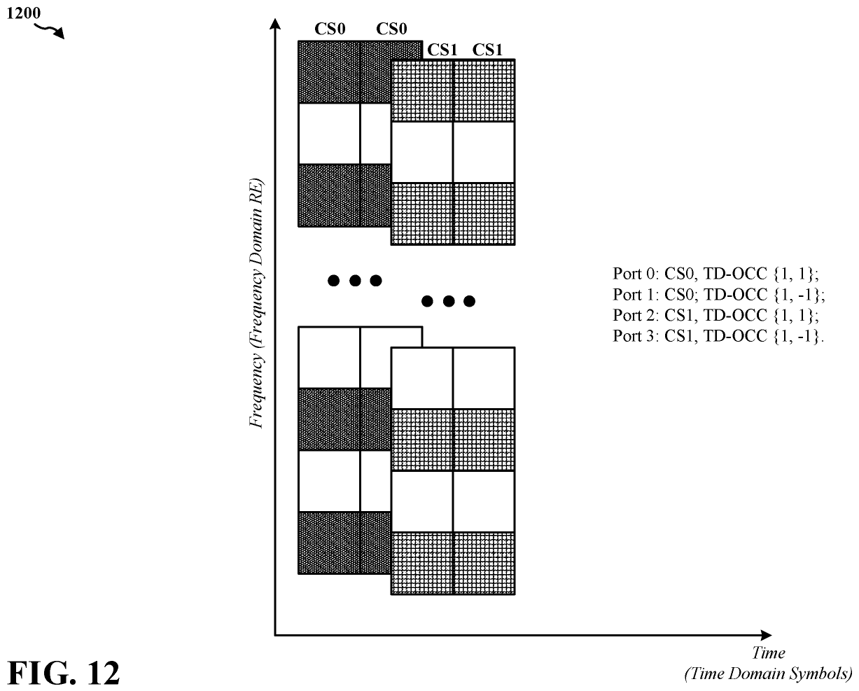

FIG. 12 is a diagram 1200 illustrating an example of cover codes for an SRS resource in the time and frequency domains. A UE may include four ports over which to sound using an SRS resource of an SRS resource set. The SRS resource may be configured on a comb-two structure. In some instances, the UE may be configured to apply both TD-OCC and FD-OCC for SRS transmission. That is, the UE may jointly use multiple cyclic shifts (e.g., FD-OCC) in the frequency domain and multiple TD-OCC in the time domain to sound all ports.

Application of the TD-OCC to SRS transmission may be compatible with application of CS to the ZC sequence used for SRS transmission, and therefore, the multiplexing capacity of resources may be increased through TD-OCC, which may provide another dimension to differentiation of SRS transmission at a base station. For example, the UE may be configured for SRS transmission with two cyclic shifts of a ZC sequence, e.g., CO and C1, in the frequency domain. The UE may additionally be configured for SRS transmission with two TD-OCC codes, e.g., {+1, +1} and {+1, −1}, in the time domain. In some aspects, the base station may configure a UE for sounding with SRS resources on which to apply TD-OCC in addition to CS (and/or another FD-OCC) in instances in which the UE is experiencing a relatively large delay spread and a relatively high Doppler spread.

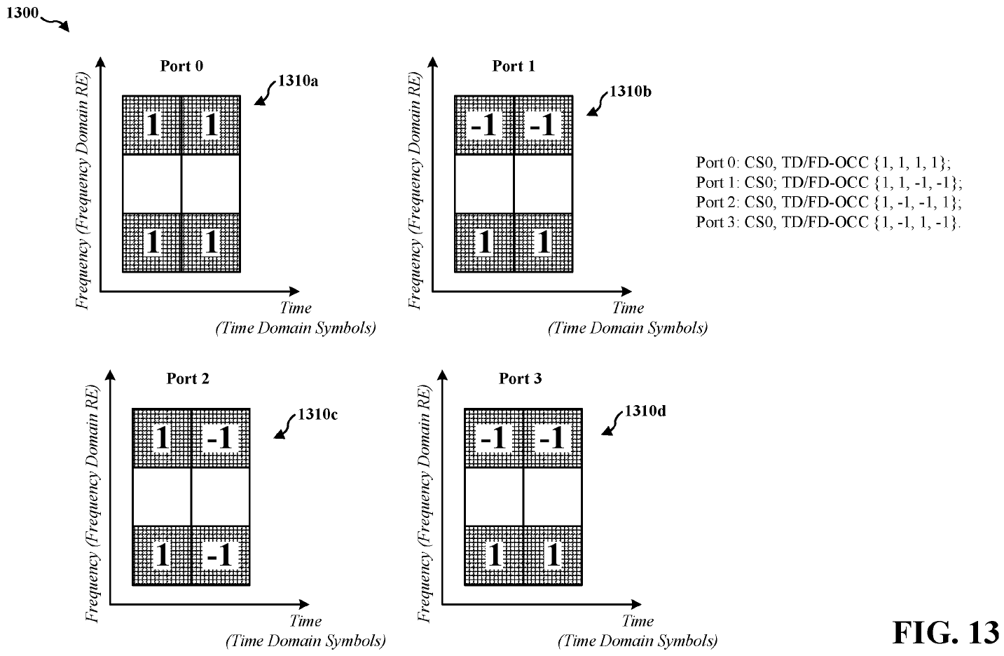

FIG. 13 is a diagram 1300 illustrating another example of cover codes for an SRS resource in the time and frequency domains. A UE may include four ports 1310a, 1310b, 1310c, 1310d over which to sound using an SRS resource of an SRS resource set. The SRS resource may be configured on a comb-two structure.

In the illustrated aspect, the UE may jointly use multiple cyclic shifts (e.g., FD-OCC) in the frequency domain and multiple TD-OCC in the time domain to sound all ports. Illustratively, the UE may be configured for SRS transmission with one cyclic shift of a ZC sequence, e.g., CO, in the frequency domain. However, the UE may additionally be configured for SRS transmission with two TD-OCC codes across two symbols, e.g., {+1, +1, +1, +1}, {+1, +1, −1, −1}, {+1, −1, −1, +1}, and {+1, −1, +1, −1}, in the time domain. In other words, the length of the TD-OCC is equal to four. Orthogonality may still be maintained by virtue of each length-4 TD-OCC. In some aspects, the base station may configure a UE for sounding with SRS resources on which to apply TD-OCC in addition to CS (and/or another FD-OCC) in instances in which the UE is experiencing a relatively large delay spread and a relatively high Doppler spread.

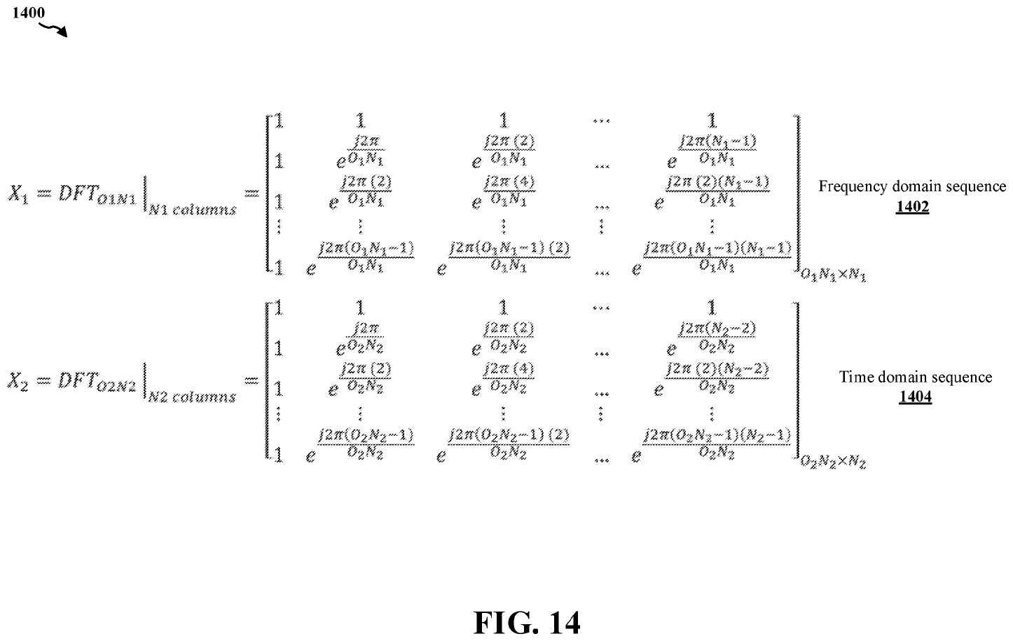

FIG. 14 is a diagram 1400 illustrating an example DFT code that may be applied in the time and frequency domains with an SRS resource. DFT codes may be regarded as cover codes, and so may be applied in a manner that is similar to that of the preceding examples in which both TD-OCC and CS (or FD-OCC) are applied for SRS transmission. Therefore, in some aspects, a base station may configure a UE for sounding with SRS resources on which to apply DFT codes in instances in which the UE is experiencing a relatively large delay spread and a relatively high Doppler spread.

To that end, the DFT codes may be two dimensional in that the DFT code may include a frequency domain sequence 1402 and a time domain sequence 1404. The DFT codes may be a function of the number of REs and oversampling factors in both the frequency domain and the time domain. For example, N1 may be the number of subcarriers in the frequency domain that may carry SRS, and N2 may be the number of symbols in the time domain that may carry SRS. The length of the sequence to use as the two-dimensional DFT codes may be the product of that number of subcarriers multiplied with that number of symbols: N1×N2.

Further, when applying two-dimensional DFT codes as the cover code, SRS transmission may be oversampled in the frequency domain by a first factor O1 and oversampled in the time domain by a second factor O2. From the oversampling, a total of O1×O2 bases may be obtained, with each basis including N1×N2 orthogonal sequences. Each sequence may then be derived as X1⊗X2 (where ⊗ denotes the Kronecker product), with X1 of length N1 and X2 of length N2 each being derived from the frequency domain sequence 1402 and the time domain sequence 1404, respectively.

As the codes in each basis are orthogonal, one UE may be configured for SRS transmission with DFT codes from one basis. However, the codes across bases are not necessarily orthogonal. Therefore, the codes from other bases may be allocated to other UEs to achieve a higher capacity.

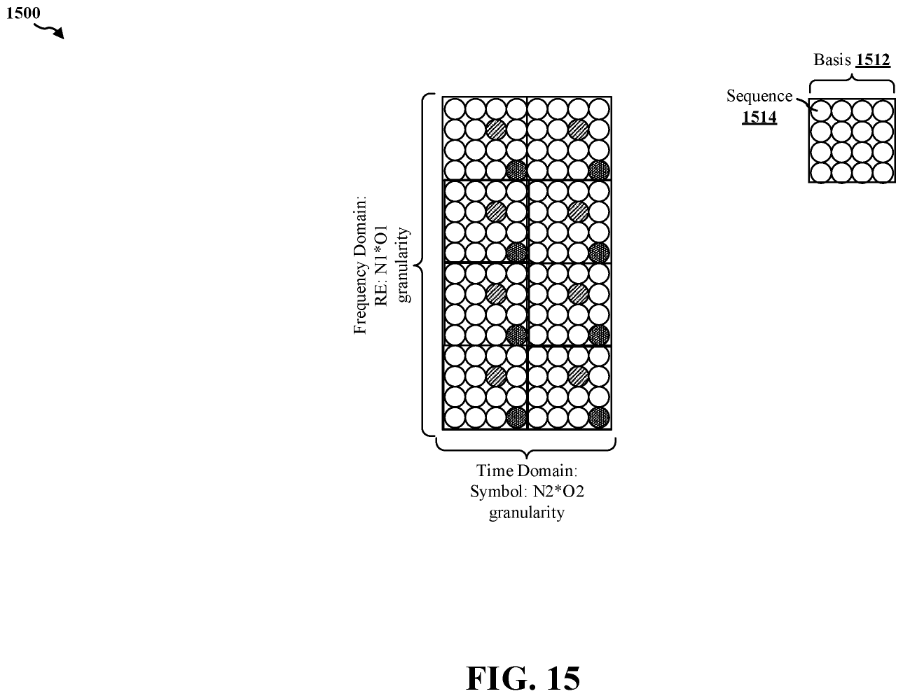

FIG. 15 is a diagram 1500 illustrating example DFT sequences in the time and frequency domains for SRS resources. A UE may be configured to use a set of orthogonal two-dimensional DFT sequences 1514 of one basis 1512 for SRS transmission, either directly or indirectly. In the context of FIG. 5, for example, the base station 502 may signal, to the UE 504, the SRS configuration 530 to configure the UE 504 with a set of orthogonal two-dimensional DFT sequences for SRS transmission. In some aspects, the base station 502 may not signal each sequence to the UE 504. Rather, the base station 502 may signal some parameters, such as an index corresponding to a basis, from which the UE 504 is able to derive the sequences in the basis that are available to the UE 504 for SRS transmission.

In some aspects, the UE (and/or base station) may generate some or all of the available sequences, and then the UE (and/or base station) may select the sequences of one basis, such as the basis assigned to the UE by the base station. As described above, the UE (and/or the base station) may generate sequences of length N1×N2, which is the product from multiplying the number of subcarriers for SRS transmission by the number of symbols for SRS transmission. Oversampling in both the frequency domain and the time domain may be at one factor O1 in the frequency domain and another factor O2 in the time domain.

The product of the number of symbols and the time-domain oversampling factor may yield a time-domain granularity of N2×O2 for SRS transmission. Similarly, the product of the number of subcarriers and the frequency-domain oversampling factor may yield a frequency-domain granularity of N1×O1 for SRS transmission.

Illustratively, the oversampling factors in both the time and frequency domains may be equal to four, while the number of symbols and subcarriers may also be equal to four. Given such values, the number of sequences that can be generated for each basis is 4×4=16. Accordingly, sixteen sequences may be supported for each UE while still maintaining orthogonality.

Once the UE has obtained the set of orthogonal sequences to use for SRS transmission, the UE may transmit each SRS resource with one of the orthogonal DFT sequences (e.g., from an assigned basis). In the context of FIG. 5, for example, the UE 504 may transmit the SRS signal(s) 534 having two-dimensional DFT sequences to sound over four ports, and orthogonality may be maintained across the SRS resources transmitted on the ports.

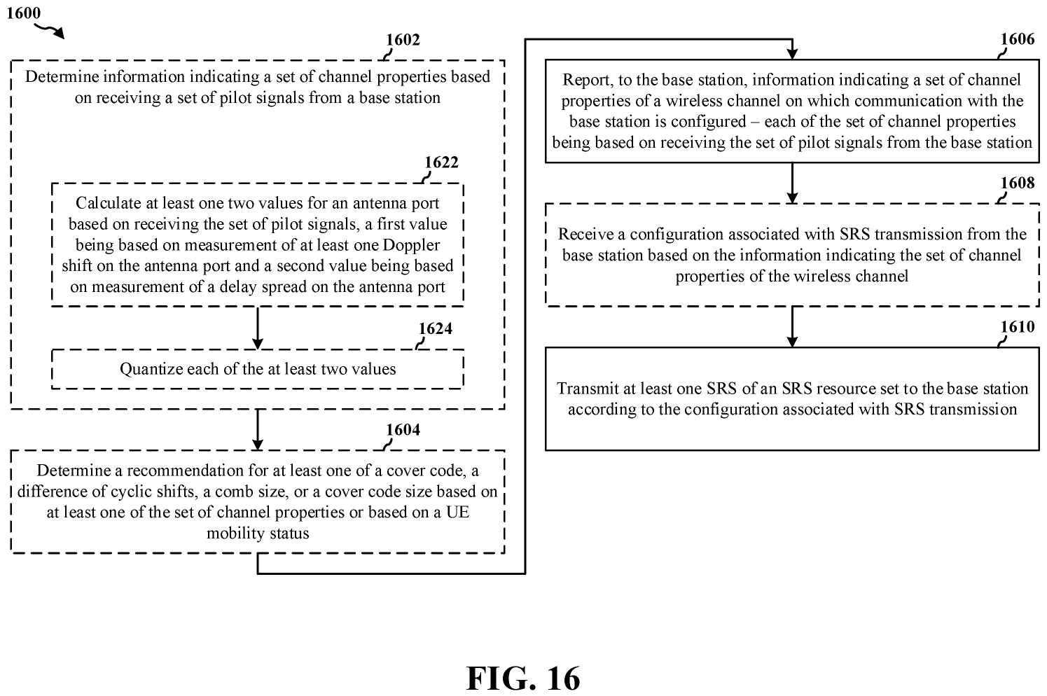

FIG. 16 is a flowchart 1600 of an example method of wireless communication by a UE. The method may be performed by a UE (e.g., the UE 104, the UE 350, the UE 504, another UE) or other apparatus. According to different aspects, one or more of the operations illustrated in the flowchart of FIG. 16 may be transposed, omitted, and/or contemporaneously performed. For example, operations illustrated with dashed lines may be omitted in some aspects.

At 1602, the UE may determine information indicating a set of channel properties based on receiving a set of pilot signals from a base station. The set of channel properties may include one or more of a delay spread, average delay, Doppler shift, Doppler spread, and/or spatial filtering parameter(s). For example, the information indicating the set of channel properties may include at least one of a Doppler shift that is measured on at least one antenna port based on at least one of the set of pilot signals, a Doppler spread calculated using the at least one Doppler shift, or a delay spread that is measured on at least one antenna port based on at least one of the set of pilot signals. Referring to FIG. 5, for example, the UE 504 may determine 524 at least one channel property based on receiving the pilot signals 522 from the base station 502.

In some aspects, one or both of 1622 and/or 1624 may be excluded from 1602. Where 1622 and/or 1624 are performed in some other aspects:

At 1622, the UE may calculate at least two values for an antenna port based on receiving the set of pilot signals. The at least two values may include a first value that is based on measurement of at least one Doppler shift on the antenna port, and further, may include a second value that is based on measurement of a delay spread on the antenna port. Referring to FIG. 5, for example, the UE 504 may determine 524 the at least one channel property by calculating at least two values for an antenna port (e.g., at least one of {1000, . . . , 1003}) based on receiving the pilot signals 522 from the base station 502.

At 1624, the UE quantize each of the at least two values. Referring to FIG. 5, for example, the UE 504 may further determine 524 the at least one channel property by quantizing the at least two values for the antenna port (e.g., at least one of {1000, . . . , 1003}).

At 1604, the determine a recommendation for at least one of a cover code, a difference of cyclic shifts, a comb size, or a cover code size based on at least one of the set of channel properties or based on a UE mobility status. The cover code may be at least one of a TD-OCC and/or an FD-OCC. Referring to FIG. 5, for example, the UE 504 may further determine 524 the at least one channel property by determining a recommendation for transmission of the SRS signal(s) 534 at least one of a cover code, a difference of cyclic shifts, a comb size, or a cover code size based on at least one of the set of channel properties or based on a UE mobility status.

For example, the UE may determine whether the Doppler spread and/or Doppler shift(s) is relatively large, such as by comparing values calculated to represent the Doppler spread and/or Doppler shift(s) to at least one threshold and/or by detecting whether the UE is in a high mobility state. If the Doppler spread and/or Doppler shift(s) is relatively large and/or the UE is in a high mobility state, the UE may recommend CS and/or another FD-OCC for SRS resources configured by the base station. In another example, the UE may determine whether the delay spread is relatively large, such as by comparing values calculated to represent the delay spread to at least one threshold and/or by detecting whether the UE is in a low or stationary mobility state. If the delay spread is relatively large and/or the UE is in a low or stationary mobility state, the UE may recommend TD-OCC for SRS resources configured by the base station. If both the Doppler spread (or shifts) and the delay spread are relatively large, the UE may recommend both CS/FD-OCC and TD-OCC for SRS transmission.

At 1606, the UE reports, to a base station, information indicating a set of channel properties of a wireless channel on which communication with the base station is configured. Each of the set of channel properties may be based on receiving the set of pilot signals from the base station. Referring to FIG. 5, for example, the UE 504 may report channel property information 526 to the base station 502.

In some aspects, the information indicating the set of channel properties may implicitly indicate the set of channel properties. For example, the information indicating the set of channel properties may include the determined recommendation for an SRS configuration. In some examples, the recommendation may be implicitly indicate a large delay spread when TD-OCC is recommended and a large Doppler spread when FD-OCC is recommended. In another example, the information indicating a set of channel properties of a wireless channel may include quantized values, e.g., for the delay spread, Doppler spread, etc. In another example, the information may explicitly indicate values for one or more of the set of channel properties.

At 1608, the UE may receive a configuration from the base station based on the information indicating the set of channel properties. The configuration may configure one or more SRS resources of one or more SRS resource sets. Further the configuration may indicate one or more schemes to be applied for SRS transmission, such as TD-OCC, FD-OCC, two-dimensional DFT codes, transmission comb, and so forth. Referring to FIG. 5, for example, the UE 504 may receive the SRS configuration 530 from base station 502 based on the channel property information 526.

At 1610, the UE transmits at least one SRS of an SRS resource set to the base station according to the received configuration that is based on the information indicating the set of channel properties. For example, the UE may apply TD-OCC and/or CS (or other FD-OCC) for SRS transmission, or the UE may apply two-dimensional DFT codes for SRS transmission. Referring to FIG. 5, for example, the UE 504 may transmit the SRS signal(s) 534 to the base station 502 according to the SRS configuration 530 that is based on the channel property information 526.

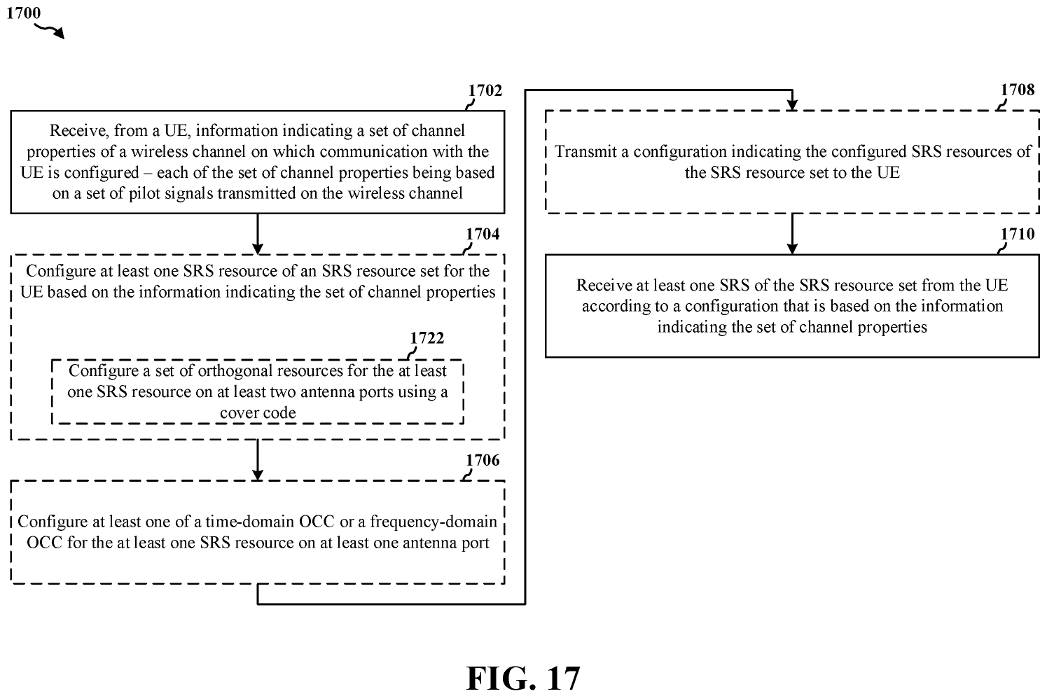

FIG. 17 is a flowchart 1700 of an example method of wireless communication by a base station. The method may be performed by a base station (e.g., the base station 102/180, the base station 310, the base station 502, another base station) or other apparatus. According to different aspects, one or more of the operations illustrated in the flowchart of FIG. 17 may be transposed, omitted, and/or contemporaneously performed. For example, operations illustrated with dashed lines may be omitted in some aspects.

At 1702, the base station receives, from a UE, information indicating a set of channel properties of a wireless channel on which communication with the UE is configured. Each of the set of channel properties may be based on a set of pilot signals transmitted on the wireless channel. In some aspects, the information indicating a set of channel properties may include a recommendation by the UE for at least one of a cover code (e.g., TD-OCC and/or FD-OCC), a difference of cyclic shifts, a comb size, or a cover code size. In some examples, the recommendation indicates at least one of a delay spread of the set of channel properties or a mobility status of the UE. In some other examples, the information indicating the set of channel properties includes at least one quantized value corresponding to at least one of a Doppler shift, a Doppler spread, or a delay spread. Referring to FIG. 5, for example, the base station 502 may receive the channel property information 526 from the UE 504.

At 1704, the base station may configure at least one SRS resource of the SRS resource set for the UE based on the information indicating the set of channel properties. For example, the base station may schedule the at least one SRS resource of the SRS resource set on radio resources of an uplink channel. Referring to FIG. 5, for example, the base station 502 may configure 528 at least one SRS resource of an SRS resource set for the UE 504 based on the channel property information 526.

In some aspects, 1722 may be excluded from 1704. Where 1722 is performed in some other aspects:

At 1722, the base station may configure a set of orthogonal resources for the at least one SRS on at least two antenna ports using a cover code. For example, the cover code may be a two-dimensional DFT code, a TD-OCC, and/or FD-OCC. Referring to FIG. 5, for example, the base station 502 may configure 528 a set of orthogonal resources for the at least one SRS resource on at least two antenna ports using a cover code.

At 1706, the base station may configure at least one of a time-domain OCC or a frequency-domain OCC for the at least one SRS resource on at least one antenna port. For example, the base station may allocate or assign an index corresponding to a set of codes to the UE. Referring to FIG. 5, for example, the base station 502 may configure 528 at least one of a TD-OCC or FD-OCC for the at least one SRS resource on at least one antenna port.

At 1708, the base station may transmit a configuration indicating the configured at least one SRS resource of the SRS resource set to the UE. The configuration may further indicate the at least one TD-OCC and FD-OCC for SRS transmission. Referring to FIG. 5, for example, the base station 502 may transmit the SRS configuration 530 indicating the configured at least one SRS resource of the SRS resource set to the UE 504.

At 1710, the base station receives at least SRS of an SRS resource set from the UE according to the configuration that is based on the information indicating the set of channel properties. Referring to FIG. 5, for example, the base station 502 may receive the SRS signal(s) 534 of an SRS resource set from the UE 504 according to the SRS configuration 530 that is based on the channel property information 526.

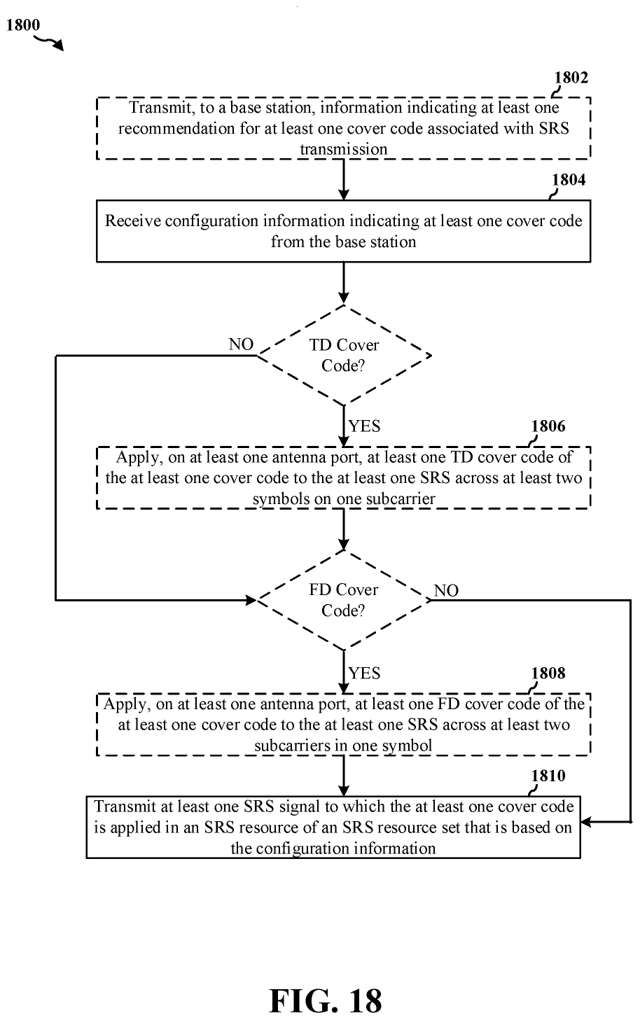

FIG. 18 is a flowchart 1800 of another example method of wireless communication by a UE. The method may be performed by a UE (e.g., the UE 104, the UE 350, the UE 504, another UE) or other apparatus. According to different aspects, one or more of the operations illustrated in the flowchart of FIG. 18 may be transposed, omitted, and/or contemporaneously performed. For example, operations illustrated with dashed lines may be omitted in some aspects.

At 1802, the UE may transmit information to a base station indicating at least one recommendation for the at least one cover code. The at least one recommendation may be based on a UE mobility status. Referring to FIG. 5, for example, the UE 504 may transmit the channel property information 526 that indicates at least one recommendation for a cover code to the base station 502.

At 1804, the UE receives configuration information indicating at least one cover code from the base station. In some aspects, the configuration may indicate at least one TD-OCC and FD-OCC for SRS transmission. In some other aspects, the configuration may further indicate both a TD-OCC and a FD-OCC for SRS transmission. In still other aspects, the configuration information may indicate a two-dimensional DFT code having dimensionality in the time domain and the frequency domain. The at least one DFT code may be based on oversampling by a first factor in the frequency domain and oversampling by a second factor in the time domain. The at least one DFT code may include at least two orthogonal DFT codes derived from a common basis. Referring to FIG. 5, for example, the UE 504 may receive the SRS configuration 530 indicating at least one cover code from the base station 502.

If the configuration information indicates a cover code in the time domain, then:

At 1806, the UE may apply, on at least one antenna port, at least one TD cover code of the at least one cover code to the at least one SRS across at least two symbols on one subcarrier. In some aspects, the UE may apply a two-dimension DFT code to the at least one SRS in the time domain. Referring to FIG. 5, for example, the UE 504 may apply, on at least one antenna port, at least one TD cover code of the at least one cover code to at least one SRS across at least two symbols on one subcarrier.

If the configuration information indicates a cover code in the time domain, then:

At 1808, the UE may apply, on at least one antenna port, at least one FD cover code of the at least one cover code to the at least one SRS across at least two subcarrier in one symbol. In some aspects, the UE may apply a two-dimension DFT code to the at least one SRS in the frequency domain. Referring to FIG. 5, for example, the UE 504 may apply, on at least one antenna port, at least one FD cover code of the at least one cover code to at least one SRS across at least two subcarriers in at least one symbol.

At 1810, the UE transmits at least one SRS signal to which the at least one cover code is applied in an SRS resource of an SRS resource set that is based on the configuration information. Referring to FIG. 5, for example, the UE 504 may transmit at least one SRS signal(s) 534 to which the at least one cover code is applied in an SRS resource of an SRS resource set that is based on the SRS configuration 530.

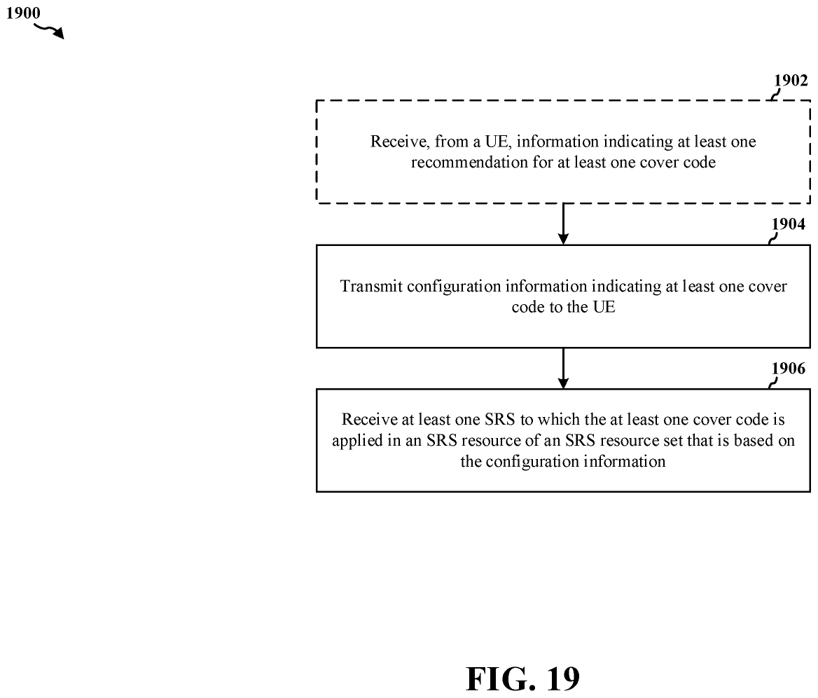

FIG. 19 is a flowchart 1900 of another example method of wireless communication by a base station. The method may be performed by a base station (e.g., the base station 102/180, the base station 310, the base station 502, another base station) or other apparatus. According to different aspects, one or more of the operations illustrated in the flowchart of FIG. 19 may be transposed, omitted, and/or contemporaneously performed. For example, operations illustrated with dashed lines may be omitted in some aspects.

At 1902, the base station may receive, from a UE, information indicating at least one recommendation for at least one cover code. The recommendation may be based on a UE mobility status of the UE. In some aspects, the recommendation may indicate TD-OCC or FD-OCC for SRS transmission. In some other aspects, the recommendation may further indicate both a TD-OCC and a FD-OCC for SRS transmission. In still other aspects, the configuration information may indicate a two-dimensional DFT code having dimensionality in the time domain and the frequency domain. The at least one DFT code may be based on oversampling by a first factor in the frequency domain and oversampling by a second factor in the time domain. The at least one DFT code may include at least two orthogonal DFT codes derived from a common basis. Referring to FIG. 5, for example, the base station 502 may receive, from the UE 504, the channel property information 526, which may indicate at least one recommendation for a cover code or other scheme that may be based on the mobility state of the UE 504.

At 1904, the base station transmits configuration information indicating at least one cover code to the UE. For example, the configuration information may indicate a first cover code to be applied to at least one SRS for transmission on an antenna port across at least two symbols on one subcarrier, and/or a second cover code to be applied to the at least one SRS for the transmission on the antenna port across at least two subcarriers in one symbol. In some aspects, the at least one cover code may be based on the at least one recommendation. Referring to FIG. 5, for example, the base station 502 may transmit, to the UE 504, the SRS configuration 530 indicating at least one cover code.

In some aspects, the configuration may indicate at least one TD-OCC and FD-OCC for SRS transmission. In some other aspects, the configuration may further indicate both a TD-OCC and a FD-OCC for SRS transmission. In still other aspects, the configuration information may indicate a two-dimensional DFT code having dimensionality in the time domain and the frequency domain. The at least one DFT code may be based on oversampling by a first factor in the frequency domain and oversampling by a second factor in the time domain. The at least one DFT code may include at least two orthogonal DFT codes derived from a common basis. Referring to FIG. 5, for example, the UE 504 may receive the SRS configuration 530 indicating at least one cover code from the base station 502.

At 1906, the base station receives at least one SRS to which the at least one cover code is applied in an SRS resource of an SRS resource set that is based on the configuration information. Referring to FIG. 5, for example, the base station may receive, from the UE 504, at least one SRS signal(s) 534 to which the at least one cover code is applied in an SRS resource of an SRS resource set that is based on the SRS configuration 530.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The following examples are illustrative only and may be combined with aspects of other embodiments or teachings described herein, without limitation.

Example 1 may be an apparatus for wireless communication at a UE, including:
a processor;
memory coupled with the processor; and
instructions stored in the memory and operable, when executed by the processor, to cause the apparatus to:
   report, to a base station, information indicating a set of channel properties of a wireless channel on which communication with the base station is configured, each of the set of channel properties being based on receiving a set of pilot signals from the base station; and
   transmit at least one SRS in an SRS resource of an SRS resource set to the base station according to a configuration that is based on the information indicating the set of channel properties.

Example 2 may be the apparatus of Example 1, and the instructions, when executed by the processor, further cause the apparatus to:
determine the information indicating the set of channel properties based on receiving the set of pilot signals from the base station; and
receive the configuration from the base station based on the information indicating the set of channel properties.

Example 3 may be the apparatus of Example 2, and the determination of the information indicating the set of channel properties includes to:
calculate at least two values for an antenna port based on receiving the set of pilot signals, a first value of the at least two values being based on measurement of at least one Doppler shift on the antenna port and a second value of the at least two values being based on measurement of a delay spread on the antenna port; and
quantize each of the at least two values,
the information indicating the set of channel properties including each quantized value of the at least two values.

Example 4 may be the apparatus of Example 3, and the information indicating the set of channel properties includes at least one of a Doppler shift that is measured on at least one antenna port based on at least one of the set of pilot signals, a Doppler spread calculated using the at least one Doppler shift, or a delay spread that is measured on at least one antenna port based on at least one of the set of pilot signals.

Example 5 may be the apparatus of any of Examples 1 or 2, and the information indicating the set of channel properties includes a recommendation for at least one of a cover code, a difference of cyclic shifts, a comb size, or a cover code size.

Example 6 may be the apparatus of Example 5, and the cover code includes at least one of a time-domain OCC or a frequency-domain domain OCC.

Example 7 may be the apparatus of Example 6, and the instructions, when executed by the processor, further cause the apparatus to:
determine the recommendation based on a UE mobility status.

Example 8 may be an apparatus of wireless communication at a base station, including:
a processor;
memory coupled with the processor; and
instructions stored in the memory and operable, when executed by the processor, to cause the apparatus to:
receive, from a UE, information indicating a set of channel properties of a wireless channel on which communication with the UE is configured, each of the set of channel properties being based on a set of pilot signals transmitted on the wireless channel; and
receive at least one SRS in an SRS resource of an SRS resource set from the UE according to a configuration that is based on the information indicating the set of channel properties.

Example 9 may be the apparatus of Example 8, and the instructions, when executed by the processor, further cause the apparatus to:
configure at least one SRS resource of the SRS resource set for the UE based on the information indicating the set of channel properties; and
transmit the configuration indicating the configured at least one SRS resource of the SRS resource set to the UE.

Example 10 may be the apparatus of Example 9, and the configuration of the at least one SRS resource of the SRS resource set includes to:
configure a set of orthogonal resources for the at least one SRS resource on at least two antenna ports using a cover code.

Example 11 may be the apparatus of any of Examples 8 to 10, and the information indicating the set of channel properties includes a recommendation by the UE for at least one of a cover code, a difference of cyclic shifts, a comb size, or a cover code size.

Example 12 may be the apparatus of Example 11, and the cover code includes at least one of a time-domain OCC or a frequency-domain domain OCC.

Example 13 may be the apparatus of Example 12, and the instructions, when executed by the processor, further cause the apparatus to:
configure the at least one of the time-domain OCC or the frequency-domain OCC for the at least one SRS resource on at least one antenna port.

Example 14 may be the apparatus of Example 13, and the recommendation indicates at least one of a delay spread of the set of channel properties or a mobility status of the UE.

Example 15 may be the apparatus of any of Examples 8 to 10, and the information indicating the set of channel properties includes at least one quantized value corresponding to at least one of a Doppler shift, a Doppler spread, or a delay spread.

Example 16 may be an apparatus of wireless communication at a UE, including:
a processor;
memory coupled with the processor; and
instructions stored in the memory and operable, when executed by the processor, to cause the apparatus to:
   receive configuration information indicating at least one cover code from a base station; and
   transmit at least one SRS to which the at least one cover code is applied in an SRS resource of an SRS resource set that is based on the configuration information.

Example 17 may be the apparatus of Example 16, and the at least one cover code includes at least one of a time-domain OCC or a frequency-domain OCC.

Example 18 may be the apparatus of Example 17, and the at least one cover code includes both the time-domain OCC and the frequency-domain OCC.

Example 19 may be the apparatus of any of Examples 16 to 18, and the instructions, when executed by the processor, further cause the apparatus to at least one of:
apply, on at least one antenna port, at least one first cover code of the at least one cover code to the at least one SRS across at least two symbols on one subcarrier; or
apply, on the at least one antenna port, at least one second cover code of the at least one cover code to the at least one SRS across at least two subcarriers in one symbol.

Example 20 may be the apparatus of any of Examples 16 to 19, and the instructions, when executed by the processor, further cause the apparatus to:
transmit information indicating at least one recommendation for the at least one cover code.

Example 21 may be the apparatus of Example 20, and the at least one recommendation is based on a UE mobility status.

Example 22 may be the apparatus of Example 16, and the at least one cover code includes at least one DFT code having a frequency-domain dimension and a time-domain dimension.

Example 23 may be the apparatus of Example 22, and the at least one DFT code is based on oversampling by a first factor in the frequency domain and oversampling by a second factor in the time domain.

Example 24 may be the apparatus of any of Examples 22 or 23, and the at least one DFT code includes at least two orthogonal DFT codes derived from a common basis.

Example 25 may be an apparatus of wireless communication at a base station, including:
a processor;
memory coupled with the processor; and
instructions stored in the memory and operable, when executed by the processor, to cause the apparatus to:
   transmit configuration information indicating at least one cover code to a UE; and
   receive at least one SRS to which the at least one cover code is applied in an SRS resource of an SRS resource set that is based on the configuration information.

Example 26 may be the apparatus of Example 25, and the at least one cover code includes at least one of a time-domain OCC or a frequency-domain OCC.

Example 27 may be the apparatus of Example 26, and the at least one cover code includes both the time-domain OCC and the frequency-domain OCC.

Example 28 may be the apparatus of any of Examples 25 to 27, and the configuration information indicates:
a first cover code of the at least one cover code to be applied to the at least one SRS for transmission on an antenna port across at least two symbols on one subcarrier, and
a second cover code of the at least one cover code to be applied to the at least one SRS for the transmission on the antenna port across at least two subcarriers in one symbol.

Example 29 may be the apparatus of any of Examples 25 to 28, and the instructions, when executed by the processor, further cause the apparatus to:
receive, from the UE, information indicating at least one recommendation for the at least one cover code, the at least one cover code being based on the at least one recommendation.

Example 30 may be the apparatus of Example 29, and the at least one recommendation is based on a UE mobility status.

Example 31 may be the apparatus of Example 25, and the at least one cover code includes at least one DFT code having a frequency-domain dimension and a time-domain dimension.

Example 32 may be the apparatus of Example 31, and the at least one DFT code is based on oversampling by a first factor in the frequency domain and oversampling by a second factor in the time domain.

Example 33 may be the apparatus of any of Examples 31 or 32, and the at least one DFT code includes at least two orthogonal DFT codes derived from a common basis.

The previous description is provided to enable any person skilled in the art to practice the various aspects described herein. Various modifications to these aspects will be readily apparent to those skilled in the art, and the generic principles defined herein may be applied to other aspects. Thus, the language employed herein is not intended to limit the scope of the claims to only those aspects described herein, but is to be accorded the full scope consistent with the language of the claims.

As one example, the language “determining” may encompass a wide variety of actions, and so may not be intended to be limited to the concepts and aspects explicitly described or illustrated by the present disclosure. In some contexts, “determining” may include calculating, computing, processing, measuring, deriving, investigating, looking up (e.g., looking up in a table, a database or another data structure), ascertaining, resolving, selecting, choosing, establishing, and so forth. In some other contexts, “determining” may include some communication and/or memory operations/procedures through which some information or value(s) are acquired, such as “receiving” (e.g., receiving information), “accessing” (e.g., accessing data in a memory), “detecting,” and the like.

As another example, reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1: A method of wireless communication at a user equipment (ULE), comprising:
reporting, to a base station, information indicating a set of channel properties of a wireless channel on which communication with the base station is configured, each of the set of channel properties being based on receiving a set of pilot signals from the base station; and
transmitting at least one sounding reference signal (SRS) in an SRS resource of an SRS resource set to the base station according to a configuration that is based on the information indicating the set of channel properties.

2: The method of claim 1, further comprising:
determining the information indicating the set of channel properties based on receiving the set of pilot signals from the base station; and
receiving the configuration from the base station based on the information indicating the set of channel properties.

3: The method of claim 2, wherein the determining the information indicating the set of channel properties comprises:
calculating at least two values for an antenna port based on receiving the set of pilot signals, a first value of the at least two values being based on measurement of at least one Doppler shift on the antenna port and a second value of the at least two values being based on measurement of a delay spread on the antenna port; and
quantizing each of the at least two values,
the information indicating the set of channel properties comprising each quantized value of the at least two values.

4: The method of claim 2, wherein the information indicating the set of channel properties comprises at least one of a Doppler shift that is measured on at least one antenna port based on at least one of the set of pilot signals, a Doppler spread calculated using the at least one Doppler shift, or a delay spread that is measured on at least one antenna port based on at least one of the set of pilot signals.

5: The method of claim 1, wherein the information indicating the set of channel properties comprises a recommendation for at least one of a cover code, a difference of cyclic shifts, a comb size, or a cover code size.

6: The method of claim 5, wherein the cover code comprises at least one of a time-domain orthogonal cover code (OCC) or a frequency-domain domain OCC.

7: The method of claim 5, further comprising:
determining the recommendation based on a UE mobility status.

8: A method of wireless communication at a base station, comprising:
receiving, from a user equipment (UE), information indicating a set of channel properties of a wireless channel on which communication with the UE is configured, each of the set of channel properties being based on a set of pilot signals transmitted on the wireless channel; and
receiving at least one sounding reference signal (SRS) in an SRS resource of an SRS resource set from the UE according to a configuration that is based on the information indicating the set of channel properties.

9: The method of claim 8, further comprising:
configuring at least one SRS resource of the SRS resource set for the UE based on the information indicating the set of channel properties; and
transmitting the configuration indicating the configured at least one SRS resource of the SRS resource set to the UE.

10: The method of claim 9, wherein the configuring the at least one SRS resource of the SRS resource set comprises:
configuring a set of orthogonal resources for the at least one SRS resource on at least two antenna ports using a cover code.

11: The method of claim 8, wherein the information indicating the set of channel properties comprises a recommendation by the UE for at least one of a cover code, a difference of cyclic shifts, a comb size, or a cover code size.

12: The method of claim 11, wherein the cover code comprises at least one of a time-domain orthogonal cover code (OCC) or a frequency-domain domain OCC.

13: The method of claim 12, further comprising:
configuring the at least one of the time-domain OCC or the frequency-domain OCC for the at least one SRS resource on at least one antenna port.

14: The method of claim 11, wherein the recommendation indicates at least one of a delay spread of the set of channel properties or a mobility status of the UE.

15: The method of claim 8, wherein the information indicating the set of channel properties comprises at least one quantized value corresponding to at least one of a Doppler shift, a Doppler spread, or a delay spread.

16: A method of wireless communication at a user equipment (UE), comprising:
receiving configuration information indicating at least one cover code from a base station; and
transmitting at least one sounding reference signal (SRS) to which the at least one cover code is applied in an SRS resource of an SRS resource set that is based on the configuration information.

17: The method of claim 16, wherein the at least one cover code comprises at least one of a time-domain orthogonal cover code (OCC) or a frequency-domain OCC.

18: The method of claim 17, wherein the at least one cover code comprises both the time-domain OCC and the frequency-domain OCC.

19: The method of claim 16, further comprising at least one of:
applying, on at least one antenna port, at least one first cover code of the at least one cover code to the at least one SRS across at least two symbols on one subcarrier; or
applying, on the at least one antenna port, at least one second cover code of the at least one cover code to the at least one SRS across at least two subcarriers in one symbol.

20: The method of claim 16, further comprising:
transmitting information indicating at least one recommendation for the at least one cover code.

21: The method of claim 20, wherein the at least one recommendation is based on a UE mobility status.

22: The method of claim 16, wherein the at least one cover code comprises at least one discrete Fourier transform (DFT) code having a frequency-domain dimension and a time-domain dimension.

23: The method of claim 22, wherein the at least one DFT code is based on oversampling by a first factor in the frequency domain and oversampling by a second factor in the time domain.

24: The method of claim 22, wherein the at least one DFT code comprises at least two orthogonal DFT codes derived from a common basis.

25: A method of wireless communication at a base station, comprising:
transmitting configuration information indicating at least one cover code to a user equipment (UE); and
receiving at least one sounding reference signal (SRS) to which the at least one cover code is applied in an SRS resource of an SRS resource set that is based on the configuration information.

26: The method of claim 25, wherein the at least one cover code comprises at least one of a time-domain orthogonal cover code (OCC) or a frequency-domain OCC.

27: The method of claim 26, wherein the at least one cover code comprises both the time-domain OCC and the frequency-domain OCC.

28: The method of claim 25, wherein the configuration information indicates:
a first cover code of the at least one cover code to be applied to the at least one SRS for transmission on an antenna port across at least two symbols on one subcarrier, and
a second cover code of the at least one cover code to be applied to the at least one SRS for the transmission on the antenna port across at least two subcarriers in one symbol.

29: The method of claim 25, further comprising:
receiving, from the UE, information indicating at least one recommendation for the at least one cover code, the at least one cover code being based on the at least one recommendation.

30: The method of claim 29, wherein the at least one recommendation is based on a UE mobility status.

31: The method of claim 25, wherein the at least one cover code comprises at least one discrete Fourier transform (DFT) code having a frequency-domain dimension and a time-domain dimension.

32: The method of claim 31, wherein the at least one DFT code is based on oversampling by a first factor in the frequency domain and oversampling by a second factor in the time domain.

33: The method of claim 31, wherein the at least one DFT code comprises at least two orthogonal DFT codes derived from a common basis.

34-134. (canceled)
